(19) United States
(12) Patent Application Publication
(10) Pub. No.: US 2009/0085762 A1
(43) Pub. Date: Apr. 2, 2009

(54) INFORMATION TRANSMITTING DEVICE, INFORMATION ACQUIRING TERMINAL, AND INFORMATION DISTRIBUTING SYSTEM

(75) Inventors: Yasuhiro Yuki, Kanagawa (JP); Nobuhiro Kambe, Tokyo (JP); Tomoaki Maruyama, Tochigi (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/994,463

(22) PCT Filed: Jul. 5, 2006
(86) PCT No.: PCT/JP2006/313384

§ 371 Date: Jan. 25, 2008

(30) Foreign Application Priority Data
Jul. 5, 2005 (JP) 2005-196106
Jul. 6, 2005 (JP) 2005-197771

(51) Int. Cl. G08B 5/00

(52) U.S. Cl. 340/691.6

(57) ABSTRACT

It is an object of the present invention to provide an information transmitting device which can transmit information through a network by using a powerless processor and insufficient storage capacity, and an information distributing system provided with the information transmitting device. The status describing unit 13 of the information transmitting device 1 produces a sentence written in natural language on the basis of the status information stored in the status storage unit 12 in response to the trigger signal from the application executing unit 11, produces a status abstract written in a markup language by marking the sentence, and stores the status abstract in the data holding unit 14. The transmission server unit 16 transmits the status abstract stored in the data holding unit 14 in response to a data transmission request received from the information acquiring terminal 2 through the network connecting unit 15.

### TECHNICAL FIELD OF THE INVENTION

The present invention relates to an information transmitting device operable to obtain information on an operation and an inside of a home appliance, measurement values of a sensor node and the like, and to transmit the information through a network, and an information acquiring terminal operable to obtain the information from the information transmitting device, and an information distributing system provided with the information transmitting device and the information acquiring terminal.

### BACKGROUND OF THE INVENTION

In recent years, the development of networked home appliances and ubiquitous computing technology have been promoted with the spread of mobile phones or with improvement of networking infrastructure. Some audio visual equipments have been already commercialized.

As one example of the networked home appliances and ubiquitous computing technology, it is well known that an information acquiring method is of obtaining various information from networked home appliances or sensor nodes.

In the above mentioned information acquiring method, a world wide web server receives, from lighting equipments, status information on whether each lighting equipment is on or off, produces a text file written in Hyper Text Markup Language (hereinafter simply referred to as “HTML”) from the status information, and outputs the text file to a central monitor (refer to, for example, Patent Document 1).

As another example of the conventional system, it is well known that measurement data written in extensible markup language (hereinafter simply referred to as “XML”) are collected from measurement devices as consolidated data. Therefore, the system can collect the measurement data without being affected by types of the measurement devices (refer to, for example, Patent Document 2). It is also known that surveillance data written in XML is collected from surveillance devices (refer to, for example, Patent Document 3).

Patent Document 1: Japanese Patent Laid-Open Publication No. H11-251072

### Patent Document 2: Japanese Patent Laid-Open Publication No. 2004-362557

### Patent Document 3: Japanese Patent Laid-Open Publication No. 2004-264995

### DISCLOSURE OF THE INVENTION

### Problems to be Solved by the Invention

In the conventional system disclosed in the Patent Document 1 or 2, each of the lighting equipment and the measurement device includes a server operable to produce data written in a markup language such as for example HTML and XML. However, each of the lighting equipment and the measurement device is too expensive or large to be used as a home appliance in a ubiquitous environment.

Although the Patent Document 3 fails to disclose a server computer, a client terminal has, in general, a powerful data processing function equivalent to that of the server computer. However, it is difficult for a home appliance or a sensor node to have a powerful data processing function equivalent to that of the server computer.

In the conventional system disclosed in the Patent Document 2, the server is required to arrange data in a predetermined order to produce the XML file having a specific data structure, while the client terminal is required to process the XML file received from the server into human readable data. Therefore, each of the server and the client terminal is required to have a relatively high processing function.

The server of the conventional data collecting system disclosed in the Patent Document 2 produces data to be distributed to the client terminal in a manner that the data are updated in synchronization with data transmission requests from the client terminal.

The conventional system disclosed in the Patent Document 2 encounters such a problem that, even if a sensor node is constituted as a server in a ubiquitous environment, it is hard for the sensor node to distribute information to a plurality of client terminals because the sensor node has only a powerless processor (CPU).

More specifically, when the server is temporarily inundated with requests, the server needs to produce on-demand data in response to the requests, and to synchronize the data with the requests by using a lock mechanism, queue processing, a reentrant mechanism and the like. It is difficult to implement the above mentioned heavily-loaded function into a powerless sensor node.

It is, therefore, an object of the present invention to provide an information transmitting device which can transmit information through a network by using a powerless processor (CPU) and insufficient storage capacity, an information acquiring terminal which can receive the information from the information transmitting device, and an information distributing system provided with the information transmitting device and the information acquiring terminal.

### Means for Solving the Problems

The information transmitting device according to the present invention, comprises: a status storage unit operable to store status information indicating a status of an appliance; a network connecting unit operable to perform communications with an external terminal through a network; a status describing unit operable to produce a sentence written in natural language on the basis of the status information, and to produce a status abstract written in a markup language by marking said sentence; a data holding unit operable to store the status abstract, and a transmission server unit operable to transmit the status abstract stored in the data holding unit in response to a data transmission request received through the network.

The information transmitting device thus constructed according to the present invention can transmit the information through the network, even if the information transmitting device is constituted by a powerless processor and cannot synchronize the status abstract with the data transmission request by processing the status abstract without a lock mechanism, queue processing, a reentrant mechanism and the like, by reason that the status storage unit stores the status information indicating the status of the appliance, and the transmission server unit transmits the status abstract stored in the data holding unit in response to the data transmission request received through the network.

In the information transmitting device according to the present invention, the status describing unit may produce the status abstract in response to changes of status information, and update the status abstract stored in the data holding unit. The information transmitting device thus constructed according to the present invention can reduce a processing load by reason that the status describing unit produces the status abstract in response to changes of status information.

In the information transmitting device according to the present invention, the status information may include information about at least one of an inner state needed to control the appliance, an operation to be performed by the appliance at specified time, and a record of an operation performed by the appliance, and a plan of an operation to be performed by the appliance after specified time, and the status information is represented by machine readable codes, and stored in the status storage unit.

In the information transmitting device according to the present invention, the natural language may be constituted by one or more human readable character strings. The information transmitting device thus constructed according to the present invention can reduce the processing load on the external terminal by reason that it is not necessary to have the external terminal further process the status abstract.

In the information transmitting device according to the present invention, the status abstract may include natural language representing the status information and at least one of basic information useful for identifying the appliance and optional information useful for supplementing the status information. The status abstract may be constituted as a combination of the natural language and a specified machine readable identifier.

The information transmitting device according to the present invention may further comprise a timer operable to measure time intervals to ensure that the status describing unit produces the status abstract at time intervals, and updates the status abstract stored in the data holding unit. The information transmitting device thus constructed according to the present invention can periodically obtain the information about the inner state or the operational status which is changing constantly.

In the information transmitting device according to the present invention, the time intervals may be changed on the basis of a frequency of the changes of the status information. The information transmitting device thus constructed according to the present invention can reduce the processing load by changing each time interval on the basis of a frequency of the changes of the status information.

In the information transmitting device according to the present invention, the appliance may be constituted by a sensor operable to obtain status information from an area around the sensor. The statue describing unit may produce the status abstract on the basis of the status information obtained by the sensor. The information transmitting device thus constructed as previously mentioned can transmit the status information obtained by the sensor to the external terminal through the network. In the information transmitting device according to the present invention, the status information may be measured by the sensor, and may indicate, as measurement values of natural phenomenon, one or more selected from among temperature, degree of humidity, height above sea level, position information, illumination intensity, radio field intensity, and current magnitude, or body temperature, body fat percentage, pulse rate, and sweating rate of a person who wears the sensor.

The information transmitting device according to the present invention may further comprise a data read unit operable to read data from the appliance by performing communications with the appliance. The status describing unit may produce the status abstract on the basis of the data read by the data read unit from the appliance. The information transmitting device as previously mentioned can obtain data from an appliance such as for example a memory medium, even if the appliance does not have a data transmission function, and transmit the data to another terminal through the network.

In the information transmitting device according to the present invention, the status describing unit may add information to the status abstract when producing the status abstract, the information being needed to identify a data read operation of the data read unit.

The information transmitting device as previously mentioned can obtain data from an appliance such as for example a memory medium, even if the appliance does not have a data transmission function, and transmit the data to another terminal through the network.

In the information transmitting device according to the present invention, the appliance may be constituted by a memory medium. The information transmitting device thus constructed according to the present invention can transmit, to another terminal through the network, data stored in a noncontact integrated circuit card (IC card), a microchip, an identification tag (ID tag), a radio frequency identification tag (RFID tag) or a device which does not have information transmitting function.

In the information transmitting device according to the present invention, the status abstract stored in the status holding unit may be constituted by status abstract elements. The transmission server unit may transmit each of the status abstract elements as a unit. The information transmitting device thus constructed as previously mentioned can transmit information through the network by using insufficient storage capacity.

In the information transmitting device according to the present invention, the status describing unit may have a template sentence storage unit operable to store one or more template sentences corresponding to status information indicating a status of an appliance. The information transmitting device thus constructed as previously mentioned can reduce processing load thereof by reason that the status describing unit produces a status abstract by incorporating the data written in a natural language and produced on the basis of the status information in a template sentence stored in the template sentence storage unit.

In the information transmitting device according to the present invention, the status describing unit may prepare an operation script to be executed by a terminal, and add the operation script to the status abstract to be received by the terminal.

The information transmitting device thus constructed as previously mentioned can be simple in operability.

In the information transmitting device according to the present invention, the status describing unit may add identification information to the operation script to be executed by the terminal, the identification information being used to designate the terminal.

The information transmitting device thus constructed as previously mentioned can reduce processing load.

In the information transmitting device according to the present invention, the operation script may include an instruction to replicate contents data and location information indicating a location of the contents data to be replicated.

The information transmitting device thus constructed as previously mentioned can instruct another terminal to make a backup file of contents file by using a powerless processor and insufficient storage capacity.

The information acquiring terminal according to the present invention, comprises: a network connecting unit operable to perform communications with an external terminal through a network; an information extracting unit operable to extract information from a status abstract received from an information transmitting device of claim 1; and an information output unit operable to output the information.

The information transmitting device thus constructed as previously mentioned can obtain information from various sensors in a sensor network constituted as the information transmitting device through a network by using a powerless processor and insufficient storage capacity.

The information acquiring terminal according to the present invention, comprises: a network connecting unit operable to perform communications with an external terminal through a network; an information extracting unit operable to extract information from a status abstract received from an information transmitting device of claim 14; an information output unit operable to output the information; and an operation information extracting and executing unit operable to extract an operation script from the status abstract, and to execute the operation script.

The information transmitting device thus constructed as previously mentioned can be simple in operability.

The information acquiring terminal according to the present invention, comprises: a network connecting unit operable to perform communications with an external terminal through a network; an information extracting unit operable to extract information from a status abstract received from an information transmitting device of claim 15; an information output unit operable to output the information; an operation information extracting and executing unit operable to extract an operation script from the status abstract, and to execute the operation script; and an identification information extracting and judging unit operable to extract, from the status abstract, identification information to be used to designate a terminal, and to judge whether or not to identify a terminal as a designated terminal on the basis of the identification information, wherein when the terminal is identified as the designated terminal by the identification information extracting and judging unit, the operation information extracting and executing unit executes the operation script.

The information acquiring terminal thus constructed as previously mentioned can reduce the processing load by judging whether or not to perform the operation on the basis of the identification information extracted from the status abstract.

The information acquiring terminal according to the present invention, comprises: a network connecting unit operable to perform communications with an external terminal through a network; an information extracting unit operable to extract information from a status abstract received from an information transmitting device of claim 15; an information output unit operable to output the information; an operation information executing unit operable to extract an operation script from the status abstract, and to execute the operation script; an identification information extracting and judging unit operable to extract, from the status abstract, identification information to be used to designate a terminal, and to judge whether or not to identify a terminal as a designated terminal on the basis of the identification information; and a data holding unit operable to store data, wherein the operation information extracting and executing unit includes a contents data replicating unit operable to extract, from the operation script, an instruction to replicate contents data and location information indicating a location of the contents data to be replicated, when the terminal is identified as the designated terminal by the identification information extracting and judging unit, and to replicate the contents data, the contents data replicating unit obtains the contents data from the information transmitting device through the network connecting unit, replicates the contents data, and stores replicated contents data in the data holding unit.

The information acquiring terminal thus constructed as previously mentioned can make a backup copy of the contents data through the network by using a powerless processor, insufficient storage capacity, and the like.

The information distributing system according to the present invention comprises: an information transmitting device including: a status storage unit operable to store status information indicating a status of an appliance; a network connecting unit operable to perform communications with an external terminal through a network; a status describing unit operable to produce a sentence written in natural language on the basis of the status information, and to produce a status abstract written in a markup language by marking said sentence; a data holding unit operable to store the status abstract, and a transmission server unit operable to transmit the status abstract stored in the data holding unit in response to a data transmission request received through the network, and an information acquiring terminal including: a network connecting unit operable to perform communications with an external terminal through the network; an information extracting unit operable to extract information from a status abstract received from the information transmitting device through the network; and an information output unit operable to output the information.

The information transmitting device stores status information indicating a status of an appliance, and transmits the status abstract stored in the data holding unit in response to the data transmission request received through the network, while the information acquiring terminal extracts information from the status abstract received from the information transmitting device, and outputs an image or a sound based on the extracted information. Therefore, the information distributing system thus constructed as previously mentioned can transmit information to another terminal through the network, even if the information transmitting device has only a powerless processor, insufficient storage capacity, and the like, without using lock mechanism, queue processing, reentrant mechanism and the like, by storing the status abstract in the status storage unit and outputting the status abstract stored in the status storage unit in response to the data transmission request.

### EFFECT OF THE INVENTION

The information transmitting device, the information acquiring terminal and the information distributing system according to the present invention have effects of distributing information through a network by using a powerless processor without synchronizing the status information producing operation and the data transmission request, and are useful for various sensors, an information distributing system and the like of network home appliances and sensor networks in a ubiquitous environment.

### BRIEF DESCRIPTION OF DRAWINGS

FIG. 1 is a block diagram showing an information transmitting device and an information acquiring terminal according to the first embodiment of the present invention.

FIG. 2 is a block diagram showing an information distributing system, according to the second embodiment of the present invention, comprising an information transmitting device and an information acquiring terminal.

FIG. 3 is a diagram showing an example of a status abstract written in a markup language, the status abstract being produced on the basis of the status information received from the information transmitting device by the information acquiring terminal according to the second embodiment of the present invention.

FIG. 4 is a diagram showing an example of the status information from the information transmitting device according to the second embodiment of the present invention.

FIG. 5 is a diagram showing an example of statuses and optional information of each home appliance constituted as the information transmitting device according to the second embodiment of the present invention.

FIG. 6 is a block diagram showing an information transmitting device according to the third embodiment of the present invention.

FIG. 7 is a block diagram showing an information transmitting device according to the fourth embodiment of the present invention.

FIG. 8 is a block diagram showing an information transmitting device and an information acquiring terminal according to the fifth embodiment of the present invention.

FIG. 9 is a block diagram showing the information distributing system, according to the fifth embodiment of the present invention, comprising the information transmitting device and the information acquiring terminal.

FIG. 10 is a block diagram showing an information transmitting device and an information acquiring terminal according to the sixth embodiment of the present invention.

FIG. 11 is a diagram showing an example of a status abstract written in a markup language, the status abstract being produced on the basis of the status information received from the information transmitting device by the information acquiring terminal according to the sixth embodiment of the present invention.

FIG. 12 is a block diagram showing an information transmitting device, an information acquiring terminal, and a third information terminal in the seventh embodiment of the present invention.

FIG. 13 is a block diagram showing an information distributing system, according to the seventh embodiment of the present invention, comprising an information transmitting device, an information acquiring terminal, and a third information terminal.

FIG. 14 is a diagram showing an example of a status abstract written in a markup language, the status abstract being produced on the basis of the status information received from the information transmitting device by the information acquiring terminal according to the seventh embodiment of the present invention.

FIG. 15 is a diagram showing an example of the information obtained from the information transmitting device by the information acquiring terminal according to the seventh embodiment of the present invention.

### DESCRIPTION OF THE REFERENCE NUMERALS

1, 6, 7, 8A, 8B and 8C: information transmitting device
11, 62, 98, 98a and 96b: application executing unit
12 and 90: status storage unit
13 and 93: status describing unit
13a and 93a: template sentence storage unit
14 and 94: network connecting unit
15: transmission server unit
16: data holding unit
17: status abstract
2, 9A, 9B, 9C: information acquiring terminal
21: information read unit
22, 96: output unit
23: network connecting unit
31: hard disc video recorder
33: electronic pot
34: rice cooker
35: wireless local area network mobile terminal
41: television set
42: mobile phone
51: stop button
52: latest information acquiring button
61: timer
71: microchip reader unit
91: data controller
92: contents data
95: script producing unit
97: input device
99: script analyzing unit
101: network
102: mobile phone network
103: microchip
104: lighting equipment
105: central control terminal

### DETAILED DESCRIPTION OF THE INVENTION

The embodiments of the information transmitting device, the information acquiring terminal, and the information distributing system according to the present invention will be described hereinafter with reference to accompanying drawings.

### First Embodiment

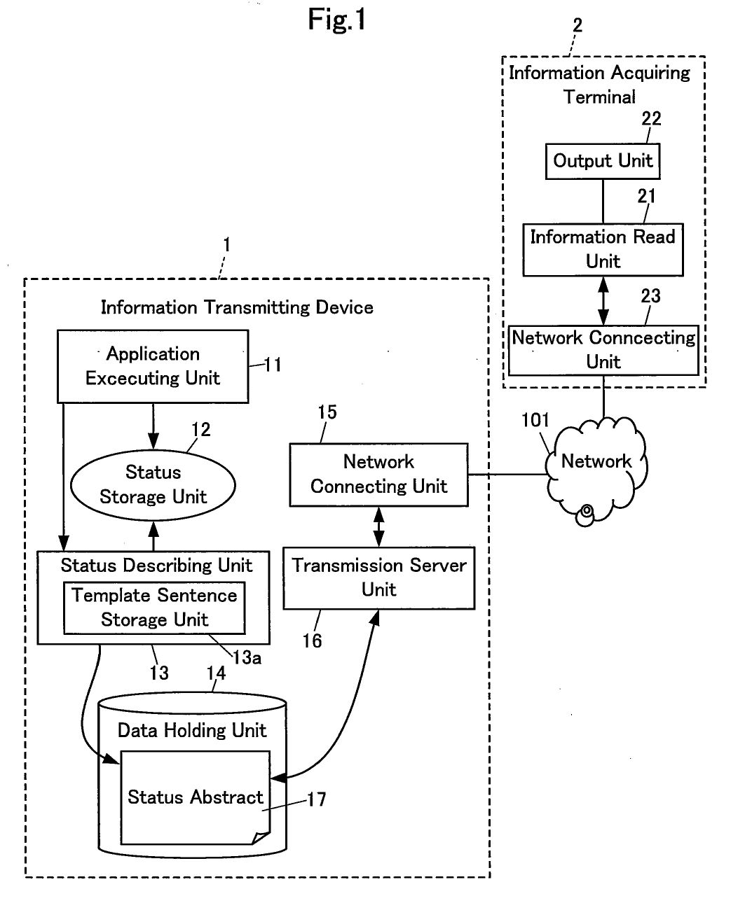

FIG. 1 is a block diagram showing an information transmitting device and an information acquiring terminal according to the first embodiment of the present invention.

As shown in FIG. 1, the information transmitting device 1 comprises an application executing unit 11 operable to execute applications to perform functions corresponding to the applications, a status storage unit 12 operable to store status information indicating changes in status of an operation of the application executing unit 11, a status describing unit 13 operable to produce, on the basis of the status information stored in the status storage unit 12, a status abstract 17 written in a markup language, the status abstract 17 including natural language and markup, a data holding unit 14 operable to hold the status abstract 17 produced by the status describing unit 13, a network connecting unit 15 operable to perform communications with another network device through a network 101, and a transmission server unit 16 operable to transmit the status abstract 17 held by the data holding unit 14 in response to data transmission request from another network device through the network 101.

The information acquiring terminal 2 comprises an information read unit 21 functioning as a data extracting unit operable to transmit data transmission request to the information transmitting device 1 through the network 101 to receive the status abstract 17 from the information transmitting device 1, to extract information from the status abstract 17, and to produce output data, an output unit 22 functioning as an information output unit operable to output the information extracted from the status abstract 17, and a network connecting unit 23 operable to perform communications with an external terminal through the network 101.

The information transmitting device 1 transmits the status abstract 17 in response to the data transmission request from another terminal. The information transmitting device 1 is constituted by a networked home appliance such as for example video recorder, hard disc video recorder, various sensors, rice cooker, and mobile phone, and various sensors connected to a network.

The application executing unit 11 executes various application programs to perform functions corresponding to the application programs in a networked home appliance such as for example video recorder, hard disc video recorder, various sensors, rice cooker, mobile phone, and a wireless local area network mobile terminal, and various sensors connected to a network. In this embodiment, the application executing unit 11 is constituted by a central processing unit (CPU) operable to execute various application programs.

The status storage unit 12 is adapted to store changes of the operation of the application executing unit 11, and constituted by a nonvolatile memory medium such as for example a hard disc and a flash memory.

The status describing unit 13 is adapted to produce a status abstract 17 by using markup language on the basis of the status information stored in the status storage unit 12, and constituted by the central processing unit (CPU).

Here, the term “natural language” is intended to indicate a human readable character string such as ward or sentence. The term “natural language including markup” is intended to indicate one or more sentences including natural language and one or more machine readable identifiers each of which is constituted by a tag defined on the basis of HTML or XML language.

The status information includes at least one of inside information needed to control an appliance, an operation to be performed by the appliance at specified time, and a record of an operation performed by the appliance, and a plan of an operation to be performed by the appliance after specified time.

The data holding unit 14 holds the status abstract 17 produced by the status describing unit 13. The data holding unit 14 may be constituted by a memory area operable to store, to update, and to delete a text file. The data holding unit 14 may be constituted by a hard disc, a flash memory and the like.

In this embodiment, the network 101 is constituted by, for example, a local area network (LAN) for home use. The communication is performed through the network 101 on the basis of Internet Protocol (IP). The present invention is not limited by the local area network. The network 101 may be constituted by the Internet, wired network such as telephone network, wireless local area network (wireless LAN), wireless network based on Bluetooth (registered trademark), or the like.

The network connecting unit 15 is connected to the network 101, and constituted by a network interface unit operable to perform communications with another networked appliances. In this embodiment, the network connecting unit 15 is constituted by network interface card for LAN, driver, transmission control protocol (TCP), protocol stack of user datagram protocol (UDP), and the like.

The transmission server unit 16 is constituted by a central processing unit (CPU). In this embodiment, the transmission server unit 16 may function as, for example, a subset of a hyper text transfer protocol server (hereinafter referred to as “HTTP server”). The transmission server unit 16 may interpret only the command “GET” from the HTTP server. The uniform resource identifier (hereinafter referred to as “URI”) defined as argument of the command “GET” may indicate only the data holding unit 14.

The information acquiring terminal 2 is constituted by a device such as for example hard disc video recorder, television set, mobile phone, rice cooker, various sensors, and wireless LAN mobile terminal. The information acquiring terminal 2 obtains the status abstract 17 from the information transmitting device 1 by transmitting the data transmission request to the information transmitting device 1, extracts information from the status abstract 17, and produces data to be outputted as image, sound, and the like.

The information read unit 21 is constituted by a central processing unit (CPU), and executes a program to obtain the status abstract 17 from the information transmitting device 1 by transmitting the data transmission request to the information transmitting device 1, extracts information from the status abstract 17, and produces data.

The output unit 22 is constituted by, for example, a television screen, a loudspeaker, a headphone or the like, and outputs an image, a sound and the like produced on the basis of the information extracted from the status abstract 17 by the information extracting unit 21.

The operation of the information distributing system provided with the information transmitting device 1 and the information acquiring terminal 2 will be described hereinafter. The following description is directed to the case that the information transmitting device 1 is constituted by a video recorder operable to store contents data in a hard disc.

The operation of the information transmitting device 1 will be firstly described hereinafter. In addition, the operation of the information transmitting device 1 is controlled by a central processing unit (CPU) built in the information transmitting device 1.

When, for example, the status of the video recorder is changed to a video recording mode from a standby mode, the application executing unit 11 of the information transmitting device 1 stores the status information in the status storage unit 12, and informs the status describing unit 13 of the change of the status.

The status describing unit 13 produces status information written in a natural language in response to a notice about the status of the application executing unit 11, produces a status abstract 17 written in a markup language, the status abstract 17 having the status information marked with a tag, and stores the status abstract 17 in the status storage unit 14, or updates the status abstract 17 previously produced and stored in the status storage unit 14. The status abstract 17 to be produced or updated by the status describing unit 13 includes at least one of basic information useful for identifying a device and optional information useful for supplementing the status information.

In this embodiment, the status describing unit 13 includes a template sentence storage unit 13a having one or more template sentences corresponding to status information indicating a status of a device. The status describing unit 13 produces status abstract 17 by incorporating the status information in the template sentence stored in the template sentence storage unit 13a in response to a notice about the status of the application executing unit 11.

The status abstract 17 thus produced in the information transmitting device 1 is obtained by the information acquiring terminal 2, and indicates the status of the application executing unit 11. The following description is directed to the operation of the information acquiring terminal 2. The operation is controlled by a central processing unit (CPU) of the information acquiring terminal 2.

The information read unit 21 of the information acquiring terminal 2 instructs the information transmitting device 1 to transmit information by transmitting data transmission request to the information transmitting device 1 through the network 101 in response to a request from the user.

The transmission server unit 16 of the information transmitting device 1 transmits the status abstract stored in the data holding unit 14 to the information requiting terminal 2 in response to the data transmission request received through the network connecting unit 15.

The information output unit 21 of the information acquiring terminal 2 analyzes the status abstract written in a markup language, extracts data written in a natural language from the status abstract, and produces, on the basis of the extracted data, data to be outputted to the output unit 22 to ensure that the output unit 22 displays, on a screen, information based on the data produced by the information output unit 21.

The information output unit 21 may analyze only one or more specific elements of the status abstract written in a markup language and received as a text file. When the judgment is made that it is hard to analyze the remaining elements of the status abstract, the information output unit 21 may skip those elements of the status abstract.

From the foregoing description, it will be understood that the information transmitting device according to the first embodiment of the present invention can transmit information to another terminal through the network even if the information transmitting device has only a powerless processor, insufficient storage capacity, and the like, and the information acquiring terminal according to the first embodiment of the present invention can be simple in construction and receive the information from the information transmitting device, by reason that the status describing unit 13 produces the status abstract indicating the status of the application executing unit 11 without using lock mechanism, queue processing, reentrant mechanism and the like, stores the status abstract in the status storage unit 14, and outputs the status abstract stored in the status storage unit 14 in response to the data transmission request.

The information transmitting device 1 according to the first embodiment of the present invention can reduce processing load thereof by reason that the status describing unit 13 produces a status abstract written in a markup language by using one or more fill-in-the-blank template sentences written in a natural language and stored in the template sentence storage unit 13a, and the transmission server unit 16 functions as a HTTP server to analyze only the command “GET” based on the Hyper Text Transfer Protocol.

The information distributing system according to the first embodiment of the present invention can reduce processing load of the information transmitting device 1 and the information acquiring terminal 2 by reason that the data written in a natural language is incorporated in the status abstract in the information transmitting device 1, and the specific elements of the status abstract is analyzed by the information transmitting device 1.

The information acquiring terminal 2 according to the first embodiment of the present invention may include only an information read unit 21 and an output unit 22, and may be constituted by a television set having an information read unit 21.

The information acquiring terminal 2 may include a sound output unit constituted by a loudspeaker and a microphone, while the information output unit 21 may produce a sound to be outputted to the sound output unit on the basis of the data extracted from the status abstract.

### Second Embodiment

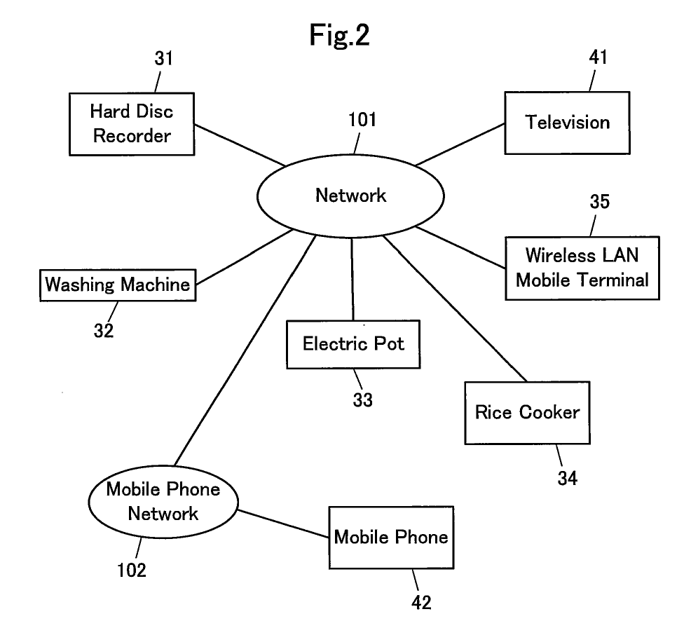

FIG. 2 is a block diagram showing an information distributing system according to the second embodiment of the present invention, the information distributing system having an information transmitting device and an information acquiring terminal. The elements of the information transmitting device according to the second embodiment substantially the same as those of the information transmitting device according to the first embodiment, and the elements of the information acquiring terminal according to the second embodiment substantially the same as those of the information acquiring terminal according to the first embodiment will not be described, but bear the same reference numerals as those of the information transmitting device and information acquiring terminal according to the first embodiment.

In this embodiment, the information transmitting device is constituted by a hard disc video recorder 31, a washing machine 32, an electric pot 33, a rice cooker 34, or a wireless LAN (local area network) mobile terminal 35. The information acquiring terminal is constituted by a television set 41, a mobile phone, or a wireless LAN mobile terminal 35.

Each of the information transmitting device and the information acquiring terminal according to the present invention may function, like a wireless local area network mobile terminal 35, not only as an information transmitting device but also as an information acquiring terminal.

The information transmitting device and information acquiring terminal is adapted to perform communications with each other through two or more networks. In this embodiment, the mobile phone 42 is wirelessly connected to a home network 101 through a mobile phone network 102, and can access a washing machine 32 and the like connected to the home network 101.

The following description is directed to the case that the television set 41 functions as the information acquiring terminal to obtain information such as for example status information from the information transmitting device, i.e., the hard disc video recorder 31, the washing machine 32, the electric pot 33, the rice cooker 34 and other home appliances, and to display the information on a screen. In this embodiment, the function as the information transmitting device in the hard disc video recorder 31 will be mainly described hereinafter for convenience of explanation.

The hard disc video recorder 31, the washing machine 32, the electric pot 33, the rice cooker 34 and other home appliances are connected to the home network 101. Here, the home network 101 is constituted by two different local area networks including a wired LAN based on 100BASE-T standard or the like and a wireless LAN based on IEEE (Institute of Electrical and Electronic Engineers) 802.11b standard or the like, connected to the Internet through a subscriber line, and connected to a mobile phone network 102 through the Internet.

Here, power line communication may be performed through power lines. The wireless communication may be performed on the basis of Bluetooth standard. The information transmitting device may access to the Internet with the help of asymmetric digital subscriber line (ADSL) or fiber to the home (FTTH).

The following description is directed to the case that the operation mode of the hard disc video recorder 31 is automatically switched to a recording mode from a standby mode at specified time. The “ABC news” will be broadcasted via television on Dec. 31, 2005 at 21:00-23:00. The hard disc video recorder 31 obtains the above mentioned information on the basis of Electronic Program Guide or another method.

At specified time, the operation mode of the hard disc video recorder 31, i.e., the operation mode of the application executing unit 11 of the hard disc video recorder 31 is changed to the recording mode from the standby mode. The status information recorded in the status storage unit 12 as the status of the hard disc video recorder 31 is firstly changed to “recording mode” from “standby mode”. The hard disc video recorder 31 may store optional information useful for supplementing the status information under the condition that the hard disc video recorder 31 has a relatively-powerful processor. In this embodiment, the application executing unit 11 stores title of television program to be recorded “ABC news”, start time and ending time “21:00-22:00 on Dec. 30, 2005” as the optional information.

More specifically, the status information written in machine readable code such as for example mnemonic language in a practical sense is stored in the status storage unit 12.

The application executing unit 11 transmits a trigger signal to the status describing unit 13 after storing the status information in the status storage unit 12.

The status describing unit 13 reads the status information from the status storage unit 12 in response to the trigger signal from the application executing unit 11. In a practical sense, “recording mode” written as status information in mnemonic language or the like, “ABC news” and “21:00-22:00 on Dec. 30, 2005” represented as optional information by character and numeral string.

The status describing unit 13 has a function useful for producing a sentence written in human readable natural language on the basis of the status information, and producing a status abstract written in a markup language. As one example, the status describing unit 13 may have a template sentence storage unit 13a operable to store fill-in-the-blank template sentences based on the status information and the optional information, and produce a status abstract written in a markup language by incorporating the status information and the optional information in the fill-in-the-blank template sentences. Although the flexibility of this method is relatively low, a program needed to produce a status abstract by using the fill-in-the-blank template sentences can be small, and can be executed by a powerless processor within a short period of time.

In this embodiment, the status describing unit 13 produces a status abstract written in a markup language by using one or more fill-in-the-blank template sentences stored in the template sentence storage unit 13a, and stores the status abstract in the data holding unit 14.

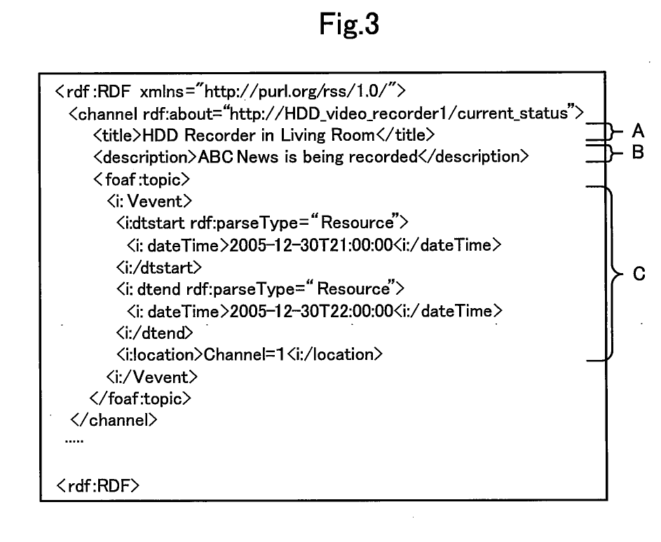

FIG. 3 is a diagram showing an example of a status abstract written in a markup language, the status abstract including a sentence written in a natural language and marked with a tag. In this embodiment, the status abstract is produced on the basis of RSS (referred to as “Resource Description Framework Site Summary (RDF Site Summary)”, “Rich Site Summary” or “Really Simple Syndication”) or Atom format.

The advantages of RSS are as follows. The Extensible Markup Language is widely used all over the world. As a program or a method useful to produce the status abstract, the HTTM may be used in place of the RSS. The WML (Wireless Markup Language) may be used in place of the RSS. The status abstract can be analyzed in the RSS reader or the like built in a personal computer or a mobile phone by reason that the fact that the format of the status abstract to be produced in the information transmitting device is the same as that of the Internet. Therefore, it is unnecessary to develop a new RSS reader to be built in a personal computer or a mobile phone. It is useful to save a memory area in which a program of the new RSS reader is stored. If its format is needed to encode to or decode from binary format, a specific program useful to encode to or decode from binary format being required to be installed into each of the information transmitting device and the information acquiring terminal, the format is unsuitable for this embodiment.

As shown in FIG. 3, the status describing unit 13 converts to a sentence written in natural language and marked with <description> tag on the basis of a combination of the operational status and the program title read from the status storage unit 12 (line “B” in FIG. 3). The start time and the ending time is converted to text data written in natural language marked with <Vevent> tag (line “C” in FIG. 3).

From the foregoing description, it will be understood that the information acquiring terminal according to the second embodiment of the present invention can display, as if a TV news program, the information extracted from the status abstract by using the RSS read function without further processing the information, and reduce the processing load by reason that the status abstract has information such as for example a record of an operation and operational status written in a natural language.

The status describing unit 13 obtains information on the name of the hard disc video recorder 31 from the hard disc video recorder 31 in addition to the status information stored in the status storage unit 12, and incorporates its own name into a line corresponding to <title> (shown by character “A” in FIG. 3). It is well known that the network device such as the hard disc video recorder 31 performs a specific operation to obtain name information about its own name. The specific operation will not be described hereinafter.

In this way, the status abstract written in a markup language such as a human readable natural language marked with a tag, and produced on the basis of the status of the hard disc video recorder 31 is stored in the data holding unit 14 of the hard disc video recorder 31. Similarly, the status abstract written in a markup language such as a human readable natural language marked with a tag, and produced on the basis of the status of the washing machine 32, the electronic pot 33 and the rice cooker 34 is stored in the data holding unit 14 of the washing machine 32, the electronic pot 33 and the rice cooker 34.

When, for example, you want to know the status of each of your home appliances from the television set 41 constituted as the information acquiring terminal according to the second embodiment while watching television, you push a start button provided on a remote controller for the television set 41 to have the television set 41 start to collect the status abstract of each of your home appliances.

When the start button is pushed by the user, the information read unit 21 of the television set 41 is started to transmit the data transmission request to the transmission server unit 16 of the hard disc video recorder 31 constituted as the information transmitting device through the network 101.

The transmission server unit 16 of the hard disc video recorder 31 reads the status abstract written in a markup language from the data holding unit 14, and transmits the status abstract to the television set 41 in response to the data transmission request from the television set 41.

In this embodiment, the transmission server unit 16 functions as a simplified HTTP (Hyper Text Transfer Protocol) server. Here, the modifier “simplified” added to the HTTP server is intended to indicate that the HTTP server has one or more restricted functions. In this embodiment, the specified HTTP server is operable to analyze only the command “GET” based on the Hyper Text Transfer Protocol. The argument “URI” of the command “GET” is limited to specific argument corresponding to the data holding unit 14.

The information transmitting device 1 thus constructed as previously mentioned can be simple in construction, produces the status abstract within a relatively short period of time by using a powerless processor, insufficient storage capacity, and the like, and transmit the status abstract to another terminal.

The information read unit 21 has a markup language analyzing function, extracts a logic structure and data written in a natural language from the status abstract, and displays data on a screen.

When, for example, one or more elements of the logic structure extracted from the status abstract cannot be analyzed by the information read unit 21, those elements may be skipped by the information read unit 21.

When, for example, “Vevent” element shown in FIG. 3 cannot be analyzed by the information read unit 21, the “Vevent” element is skipped by the information read unit 21.

In this manner, the information read unit 21 of the television set 41 receives information from the hard disc video recorder 31.

The information read unit 21 of the television set 41 receives information from the transmission server unit 16 of each of a washing machine 32, an electric pot 33, and a rice cooker 34.

In addition, as a method of obtaining a list of information transmitting devices 1 connected to the network 101, the Universal Plug and Play (UPnP) standard may be used in the information acquiring terminal 2.

When the information read unit 21 of the television set 41 receives the information from all of the information transmitting devices, the information read unit 21 of the television set 41 produces data to be outputted to the output unit 22. In this embodiment, the information read unit 21 can produces the text data to be directly outputted to the output unit 22.

If the output unit 22 is able to output not only characters but also an image on a screen of the television set 41, and to output a sound through loudspeakers of the television set 41, and the information read unit 21 has a relatively high processing function needed to analyze or process data, the information read unit 21 may output not only characters but also an image on the screen of the television set 41, and output a sound through the loudspeakers of the television set 41. The information read unit 21 may add non-character information such as color to each element of text data written in a markup language, and adjust its color density.

When each of the information transmitting device and the information acquiring terminal has a powerful processor, sufficient storage capacity, and the like, the above mentioned additional elements may be analyzed in each of the information transmitting device and the information acquiring terminal. When, for example, the information transmitting device has a powerful processor, sufficient storage capacity, and the like, and the information acquiring terminal has a powerless processor, insufficient storage capacity, and the like, the additional elements may be skipped without being analyzed in the information acquiring terminal. When, on the other hand, the information transmitting device has a powerful processor, sufficient storage capacity, and the like, and the information acquiring terminal has a powerless processor, insufficient storage capacity, and the like, the additional elements cannot be contained in the status abstract to be transmitted to the information acquiring terminal.

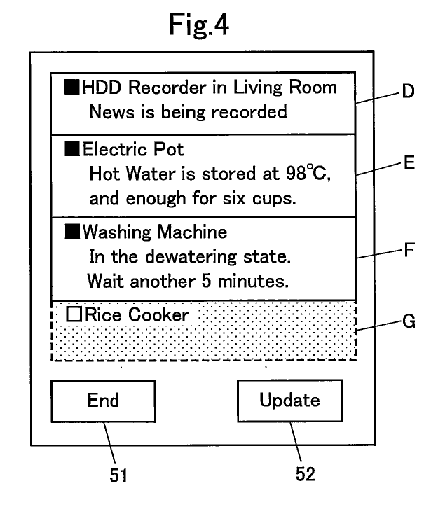

FIG. 4 is a diagram showing an example of the status information from the information transmitting device according to the second embodiment of the present invention.

As shown in FIG. 4, the information about the status of the hard disc video recorder 31 is shown in an area “D”. In this example, text data of the title element (corresponding to line “A” in FIG. 3) and text data of the description element (corresponding to line “B” in FIG. 3) are displayed on respective areas of the screen. On the other hand, text data of the “Vevent” element (corresponding to line “C” in FIG. 3) are skipped without being analyzed in the information read unit 21.

The area “G” corresponding to the information from the rice cooker 34 is shaded when the rice cooker 34 is in an OFF state, or the rice cooker 34 cannot transmit the information in response to the data transmission request. The shaded area may be replaced with a colored area different in color from the remaining area. As another example, the characters of the shaded area may be paled out.

When the end button 51 is selected by a user, the television set 41 completes the image displayed on the basis of information on the screen, and displays the television program. When, on the other hand, the update button 52 is selected by the user, the television set 41 transmits the data transmission request to another appliance.

Additionally, the characters may be displayed on the basis of a telop (ticher) method, or may be displayed as translucent characters. The above mentioned methods may be selectively used on the basis of data processing and displaying capacity the information acquiring terminal 2.

If the information acquiring terminal 2 has a sound producing function, the information acquiring terminal 2 may produce a sound on the basis of the text data written in a natural language. When, for example, the information acquiring terminal 2 fails to have an image producing function, or the information acquiring terminal 2 has only a specific image producing function, it is useful to produce a sound by using the sound producing function. The information acquiring terminal 2 may have not only a sound producing function and but also a specific image producing function.

The text data written in a natural language may be transmitted to another device without being displayed on the screen of the information acquiring terminal 2, and may be displayed on a screen of another device. If the information acquiring terminal 2 has an E-mail transmitting function, the text data written in a natural language may be attached to an E-mail to be transmitted to another mailer terminal without being processed by the information acquiring terminal 2.

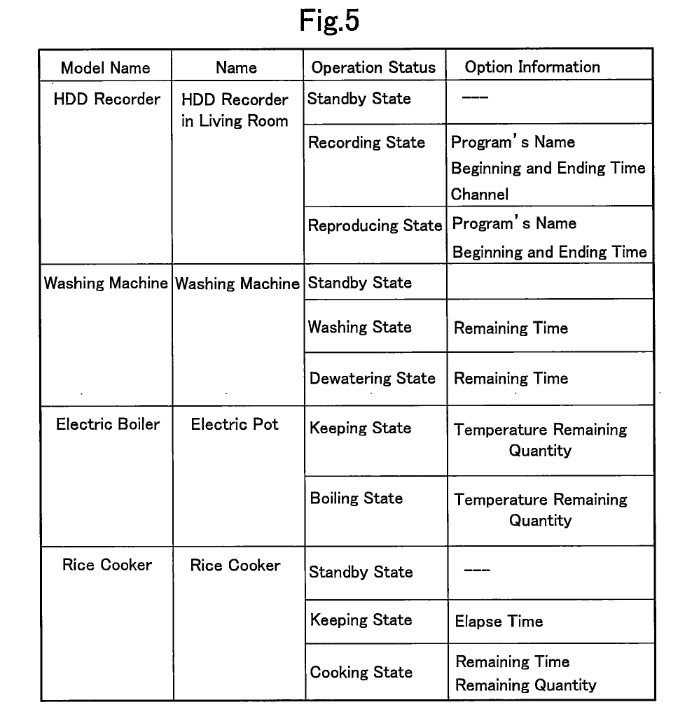

FIG. 5 is a diagram showing an example of statuses and optional information of the hard disc video recorder 31, the washing machine 32, the electric pot 33, the rice cooker 34, or other home appliance constituted as the information transmitting device according to the second embodiment of the present invention.

As shown in FIG. 5, the status information written in a natural language indicates the change of the status of the application executing unit 11. However the status information is written on the basis of machine readable code such as mnemonic language or another non-natural language.

From the foregoing description, it will be understood that the information transmitting device according to the second of the present invention can transmit information to another terminal through the network even if the information transmitting device has only a powerless processor, insufficient storage capacity, and the like, and the information acquiring terminal according to the first embodiment of the present invention can be simple in construction and receive the information from the information transmitting device, by reason that the status describing unit 13 produces the status abstract indicating the status of the application executing unit 11 without using lock mechanism, queue processing, reentrant mechanism and the like, stores the status abstract in the status storage unit 14, and outputs the status abstract stored in the status storage unit 14 in response to the data transmission request.

In this embodiment, the information acquiring terminal starts to collect the information by when the information collecting button is pushed by a user. The present invention is not limited to the above mentioned case. For example, the information acquiring terminal may transmit the data transmission request at regular intervals, or may start to collect the information on the basis of one or more conditions needed to start to collect the information.

As an example, the information collecting operation may be performed in response to a judgment that the lighting equipment in one's living room is power on. The lighting equipment may be inform about the judgment that the lighting equipment in one's living room is power on. The information acquiring terminal may transmit at regular intervals the data transmission request to the lighting equipment. The information acquiring terminal may transmit the data transmission request to a sensor node provided in the living room, while the sensor node may measure the change in light intensity of the lighting equipment.

While there has been described in the foregoing description about the fact that the status information indicates the operation of the hard disc video recorder, the present invention is not limited to the hard disc video recorder. The status information may indicate an operation of another appliance, or may be measured by a sensor as natural phenomenon, and constituted by measurement values of one or more selected from among temperature, degree of humidity, height above sea level, position information, illumination intensity, radio field intensity, and current magnitude, or body temperature, body fat percentage, pulse rate, sweating rate and the like of a person who wears the sensor.

### Third Embodiment

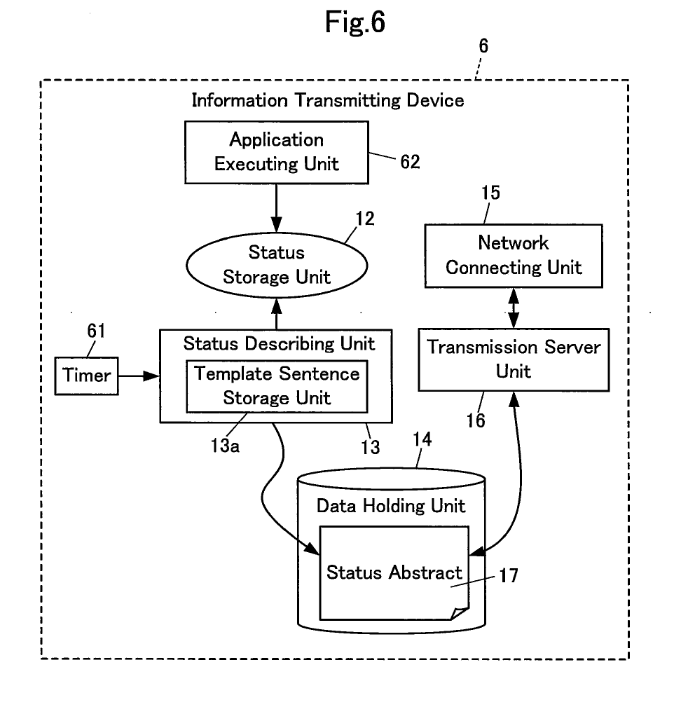

FIG. 6 is a block diagram showing an information transmitting device according to the third embodiment of the present invention. The elements of the information transmitting device according to the third embodiment substantially the same as those of the information transmitting device according to the first embodiment, and the elements of the information acquiring terminal according to the third embodiment substantially the same as those of the information acquiring terminal according to the first embodiment will not be described, but bear the same reference numerals as those of the information transmitting device and information acquiring terminal according to the first embodiment.

As shown in FIG. 6, the information transmitting device 6 according to the third embodiment comprises elements the same as those of the information transmitting device 1 according to the first embodiment, and a timer 61 operable to measure intervals to produce a trigger signal to be outputted to the status describing unit 13. The status describing unit 13 produces, at intervals, a status abstract written in a markup language, the status abstract including natural language and markup, and updates the status abstract stored in the data holding unit 14.

In this embodiment, the status of a device realized by the application executing unit 62 is being continuously fluctuated with time. Therefore, it is hard to accurately relate the time to fluctuations of the status of the application executing unit 62. The time associated with the status of the device is discretely written to the status storage unit 12.

In this embodiment, the information transmitting device 6 according to the third embodiment receives status information from a temperature sensor node identified as a target device. The application executing unit 62 functions as a temperature sensor. Therefore, the status of the application executing unit 62 indicates temperature measured by the temperature sensor. The temperature sensor may be constituted as a sensor separated from the temperature sensor node.

When the timer 61 triggers the application executing unit 62 at intervals, for example, every ten minutes, the application executing unit 62 measures a temperature of a target object as status information every ten minutes, and stores the status information in the status storage unit 12, and updates the previous status information stored in the status storage unit 12. When the data transmission request is transmitted to the information transmitting device 6 from the information acquiring terminal 2, the temperature measured in ten minutes can be received by the information acquiring terminal 2. The information acquiring terminal 2 can inform a user of the temperature measured in ten minutes.

It is not essential to keep each of the intervals constant. For example, the judgment may be made whether or not the fluctuations of the temperature of the target object, more specifically, the differential value of the temperature of the target object exceeds a threshold value. When the differential value of the temperature of the target object exceeds the threshold value, the interval to be measured by the timer 61 may be decreased. When, on the other hand, the differential value of the temperature of the target object does not exceed the threshold value, the interval to be measured by the timer 61 may be increased.

From the foregoing description, it will be understood that the information transmitting device according to the third embodiment can transmit measurement data from the sensor to another terminal through the network by using powerless processor, insufficient storage capacity, and the like by reason that the status information includes information to be obtained by the sensor from the target object, the status describing unit 13 produces a status abstract on the basis of the information obtained by the sensor from the target object.

The information transmitting device according to the third embodiment can collect the inside information or the status information at intervals even if the inside status or the operational status to be measured as the status information is being fluctuated with time by reason that the information transmitting device comprises a timer operable to measure each of the intervals to trigger the status describing unit, the status describing unit produces a status abstract in response to the trigger signal from the timer, and updates the status abstract stored in the data holding unit.

The information transmitting device according to the third embodiment can reduce processing load by changing each interval to be measured by the timer, even if the inside status or the operational status to be measured as the status information is being fluctuated with time, by reason that each of the intervals to be measured by the timer is changed on the basis of a frequency of the changes of the status information.

The following description will be directed to the case that the information transmitting device is applied to a battery. In this case, the temperature sensor node is replaced with a battery as an appliance targeted for status information. The information transmitting device 6 includes, in place of an application executing unit 62 functions as a sensor operable to sense a temperature, an application executing unit 62 functions as a sensor operable to sense a remaining battery level. In this embodiment, the information transmitting device is contained in the battery. However, the battery and the information transmitting device may be understood as being distinct from each other.

In order to reduce the drain on battery power, it's preferable to repeatedly obtain status of the battery in a relatively long period if the information transmitting device is contained in the battery. On the other hand, it is difficult to measure the status of the battery with accuracy. In this case, the information transmitting device may produce a trigger signal needed to request the status describing unit 13 to obtain status information from the application executing unit functioning as a sensor operable to sense a remaining time of the battery without a timer 61. The status describing unit 13 produces the status abstract on the basis of the status information stored in the status storage unit 12.

If the information transmitting device 6 according to the third embodiment cannot reserve an available memory area for the status abstract in the data holding unit 14, for example, in a random access memory (RAM) when the status abstract is transmitted by the information transmitting device 6 according to the third embodiment transmits in response to the data transmission request, the information transmitting device 6 may produce a status abstract sequentially on the basis of last status information stored in the status storage unit 12. In this embodiment, the information transmitting device 6 produces a status abstract one line at a time, and stores the status abstract in the data holding unit 14 in sequence order. The information transmitting device 6 may produce a status abstract two or more lines at a time. The information transmitting device 6 may produce a status abstract smaller than two or more lines at a time.

The transmission server unit 16 transmits, in sequential order, the status abstract 17 produced by the status describing unit 13 to the information acquiring terminal 2 through the network connection unit 15. Then, the transmission server unit 16 instructs the status describing unit 13 to produce the next status abstract 17, and receive the next status abstract 17 from the status describing unit 13. When the transmission of the last line of the status abstract 17 is complete, the status describing unit 13 outputs notification of the transmission of the last line of the status abstract 17 to the transmission server unit 16. The transmission server unit 16 terminates the connection between the network connecting unit 15 and the information acquiring terminal 2 in response to the notification from the status describing unit 13.

In the information transmitting device 6, the status abstract 17 stored in the data holding unit 14 is constituted by status abstract elements. The transmission server unit 16 transmits each of the status abstract elements as a unit. The data holding unit 14 may not have an enough free space to have the status abstract stored therein. Therefore, the information transmitting device can transmit the status abstract the information acquiring terminal even if the information transmitting device has a powerless processor and an insufficient storage capacity.

From the foregoing description, it will be understood that the information transmitting device according to the third embodiment of the present invention can be applied to a battery, and perform an operation by using a powerless processor, insufficient storage capacity, and relatively low power. The information acquiring terminal according to the third embodiment of the present invention can be simple and obtain information from the information transmitting device.

In this embodiment, the information transmitting device and the target device are collectively constituted as a device. However, the present invention is not limited to the foregoing embodiment. The information transmitting device may be constituted as a device separate from the target device, and obtain the status information indicating the status of the target device. The following description is directed to the case that the information transmitting device is constituted as a device separate from the target device.

### Fourth Embodiment

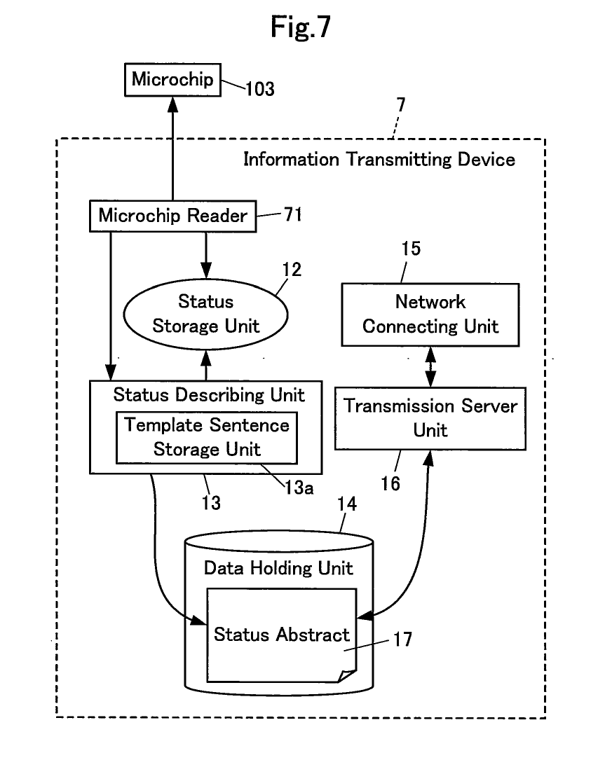

FIG. 7 is a block diagram showing an information transmitting device according to the fourth embodiment of the present invention. The elements of the information transmitting device and information acquiring terminal according to the fourth embodiment substantially the same as those of the information transmitting device and information acquiring terminal according to the first embodiment will not be described, but bear the same reference numerals as those of the information transmitting device and information acquiring terminal according to the first embodiment.

As shown in FIG. 7, the information transmitting device 7 according to the fourth embodiment is constituted by a microchip 103. In place of the application executing unit 11, the information transmitting device 7 according to the fourth embodiment comprises a microchip reader 71 for receiving the status information from the microchip 103, storing the status information in the status storage unit 12, and outputting a trigger signal to the status describing unit 13.

The microchip 103 may be constituted by a radio frequency identification (RFID) tag, a contact-free integrated circuit (IC) card and the like.

For example, the information transmitting device 7 may be constituted by a microchip reader 103. In general, the microchip 103 is difficult to have various functions except for a function of transmitting its information to the microchip reader 71.

In this embodiment, the microchip reader 71 has a transmitting function.

When the information transmitting device 7 is close to the microchip 103, the microchip reader 71 performs communication with the microchip 103 on the basis of a specific protocol to receive its name and other information from the microchip 103. In this embodiment, the microchip reader 71 functions as an information read unit.

The microchip reader 71 stores the information obtained from the microchip 103 in the status storage unit 12 after completing the readout operation, and transmits a trigger signal to the status describing unit 13.

In a manner similar to that of the foregoing embodiment, the status describing unit 13 produces a status abstract written in a markup language on the basis of the information from the status storage unit 12, and stores the status abstract in the data holding unit 14. On the other hand, the information acquiring terminal 2 obtains the status abstract from the information transmitting device 1 in a similar manner. Additionally, the status describing unit 13 may incorporate optional information in the status abstract, the optional information indicating the time and position, the number of data read operation, and user's information.

From the foregoing description, it will be understood that the information acquiring terminal according to the present invention can be simple in construction by reason that the information transmitting device is separated from a target device constituted by a memory medium such as for example a microchip and an integrated circuit tag (hereinafter simply referred to as “IC tag”).

In this embodiment, the target device is constituted by a microchip 103. The information transmitting device 7 includes, in place of the application executing unit 11, a microchip reader 71 operable to read information from a microchip 103. Even if the information produced by the microchip 103 fails to be directly received by another device, and fails to be stored in the microchip 103, the information transmitting device 7 according to the fourth embodiment can read, in place of the device, the information from the microchip 103, and transmit the information from the from the microchip 103.

In this embodiment, the target device is constituted by a microchip 103. However, the target device may be constituted by another device different from the microchip 103. The information transmitting device 7 may include, in place of the microchip reader 71, data read means operable to read information from a memory medium such as for example an IC tag.

While there has been described in the foregoing description about the fact that the status abstract written in a markup language is produced by the status describing unit 13, the status abstract being constituted by as a combination of human readable natural language and specific machine readable identifier, the present invention is not limited to a specified machine readable identifier. The status describing unit may incorporate machine readable information to the status abstract. The following description is directed to the case that the status abstract received by a terminal includes an operation script to be executed by the terminal.

### Fifth Embodiment

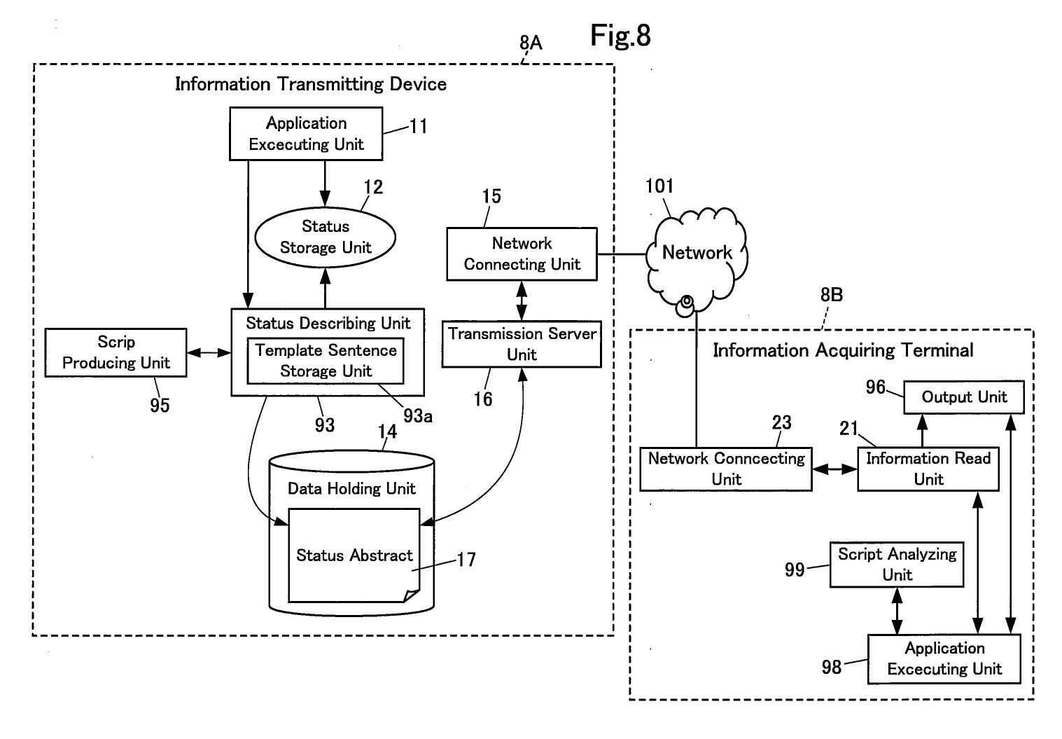

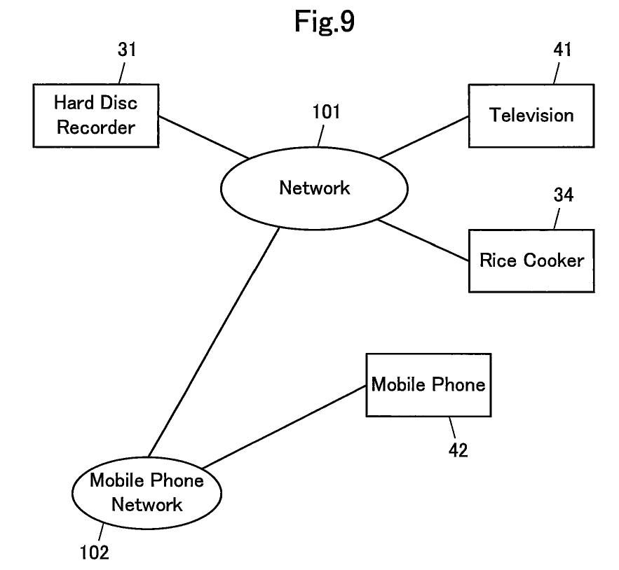

FIG. 8 is a block diagram showing an information transmitting device and an information acquiring terminal according to the fifth embodiment of the present invention. FIG. 9 is a block diagram showing the information distributing system, according to the fifth embodiment of the present invention, comprising the information transmitting device and the information acquiring terminal. The elements of the information transmitting device and information acquiring terminal according to the fifth embodiment substantially the same as those of the information transmitting device and information acquiring terminal according to the first embodiment will not be described, but bear the same reference numerals as those of the information transmitting device and information acquiring terminal according to the first embodiment.

As shown in FIG. 8, the information transmitting device 8A according to the fifth embodiment includes elements which are substantially the same as those of the information transmitting device 1 according to the first embodiment. In place of the status describing unit 13, the information transmitting device 8A comprises a status describing unit 93 operable to produce a status abstract 17 from the status information stored in the status storage unit 12 on the basis of markup language, and to issue an instruction to prepare an operation script, and a script producing unit 95 operable to produce, in response to the instruction issued by the status describing unit 93, an operation script executable in another device. The status describing unit 93 incorporates the operation script prepared the script producing unit 95 in the status abstract 17, and marks the operation script incorporated in the status abstract 17 with a tag for designating an operation. On the other hand, the information acquiring terminal 8B according to the fifth embodiment comprises a script analyzing unit 99 operable to extract the operation script from the status abstract 17 by using the tag, and to analyze the operation script extracted from the status abstract 17, and an application executing unit 98 operable to execute the operation script analyzed by the script analyzing unit 99 in response to the instruction from the information read unit 21. In place of the output unit 22 of the first embodiment, the information acquiring terminal 8B comprises an output unit 96 operable to perform an operation in response to the operation of the application executing unit 98.

In FIG. 9, the information transmitting device 8A is constituted by a mobile phone. On the other hand, the information acquiring terminal 8B is constituted by a television set 41, a hard disc video recorder 31, a rice cooker 34 or the like. The script analyzing unit 99 and the application executing unit 98 collectively constitute an operation information extracting and executing unit.

The mobile phone 42 functions as the information transmitting device 8A, and comprises an application executing unit 11 operable to execute a scheduler, and having an alarm function. When schedule information such as for example tomorrow's schedule, destination, items necessary for tomorrow's schedule, and wake-up time are inputted into the application executing unit 11, the schedule information is stored in the status storage unit 12 in this embodiment.

The status describing unit 93 issues, in response to a notice from the application executing unit 11 or by reading the schedule information stored in the status storage unit 12, an instruction to the script producing unit 95 to produce, as information to be shared with another devices, for example, information needed to have the application executing unit 11 perform the alarm function, an operation script based on tomorrow's wake-up time, the operation script being analyzed and executed by another devices. Furthermore, the status describing unit 93 produces a sentence written in human readable natural language on the basis of the schedule information read from the status storage unit 12, produces a status abstract written in a markup language, the status abstract including external terminal readable operation script and markup, and stores the status abstract in the status storage unit 14.

More specifically, the information read unit 21 of the information acquiring terminal 8B analyzes the status abstract 17 written in a markup language and received from the information transmitting device 8A, outputs, to the output unit 96, the status information written in a human readable natural language and extracted from the status abstract 17, and outputs, to the application executing unit 98, the operation script marked with the tag and extracted from the status abstract 17. The output unit 96 outputs an image or a sound produced on the basis of the status information from the information read unit 21. The application executing unit 98 requests the script analyzing unit 99 to analyze the operation script from the information read unit 21, and performs an operation based on an analysis of the operation script. For example, the application executing unit 98 controls the output unit 96 to ensure that the output unit 96 outputs a beep sound based on the analysis of the operation script.

For example, the mobile phone 42 constituted as the information transmitting device 8A produces an alarm clock script on the basis of time information inputted as a time for a user to wake up in tomorrow morning, and incorporates the alarm clock script into the status abstract. On the other hand, terminals each constituted as the information acquiring terminal 8B obtains the status abstract provided with the alarm clock script marked with a tag, displays the schedule information extracted from the status abstract on a screen, and performs an operation on the basis of the alarm clock script. For example, the television set 41 is, as one of the terminals, automatically powered on at a time specified by the alarm clock script, and displays today's schedule, destination, items necessary for today's schedule and the like. The rice cooker 34 starts as one of the terminals to cook rice in consideration with the wake-up time, and completes the rice cooking operation before the wake-up time. As one of the terminals, the hard disc video recorder 31 converts in format the recoded television program data into video data which can be displayed on a screen of the mobile phone 42, transmits the video data to the mobile phone 42 through the network, and completes the transmission of the video data transmission operation before the wake-up time indicated by the alarm clock script.

Here, the alarm clock script has been described as an example of a script in this embodiment, and as being produced on the basis of the schedule information. However, the script may be produced on the basis of information about the remaining amount of electronic money, on/off control of a designated device, or an operation needed to make a copy of video data. The contents to be outputted by the output unit 96 are not limited to characters to be displayed on a screen, a sound and the like.

In this embodiment, the script executable in another terminal is produced from the information inputted from the application executing unit 11 of the information transmitting device 8A. The status abstract is produced and stored in the status storage unit 14, the status abstract including the inputted information and the script executable in another device. On the other hand, the information acquiring terminal 8B receives the status abstract from the information transmitting device 8A, displays the information contained in the status abstract on a screen, and detects the executable script from the status abstract. The information transmitting device 8A does not have to manage the distribution of the executable script by reason that the status abstract stored in the information transmitting device 8A is received by two or more information acquiring terminals 8B when needed. Therefore, each of the information transmitting devices 8A can transmit the status abstract including an executable script to a plurality of information acquiring terminals through a network, each of the information acquiring terminals 8B can receive the status abstract to execute the script, even if each of the information transmitting devices 8A and each of the information acquiring terminals 8B have only a powerless processor and insufficient storage capacity, and the like.

While there has been described in this embodiment about the fact that the status describing unit adds an operation script to the status abstract to be transmitted to one or more terminals, the operation script being executed by the terminals when needed. However, the status describing unit may add identification information needed to identify a terminal to the operation script. In this case, the information acquiring terminal comprises, in addition to an operation information extracting and executing unit, an identification information extracting and judging unit operable to extract identification information from the operation script, and to identify a terminal as a designated terminal on the basis of the extracted identification information. The operation information extracting and executing unit is constituted by a script analyzing unit 99 and an application executing unit 98. The identification information extracting and judging unit extracts the identification information from the operation script extracted from the status abstract received from the information transmitting device, and identifies a terminal as a designated terminal on the basis of the extracted identification information. When the identification information extracting and judging unit identifies the extracted information as the identification information, the operation information extracting and executing unit executes the operation script. A method of adding the identification information to the operation script, a method of extracting the identification information from the operation script, and identifying the extracted information as the identification information, and the like will not be described hereinafter as a conventional method.

While there has been described in the foregoing description about the fact that the status abstract produced by the status describing unit 13 of the hard disc video recorder constituted as the information transmitting device includes, as an optional information, basic information useful to identify a device and television program information useful to specify TV program. The present invention is not limited to the foregoing embodiment. The status abstract may include, as the optical information, information useful to identify an operation. If the information acquiring terminal has a data read function, the status abstract may include, as the optional information, information useful to specify a data read operation.

### Sixth Embodiment

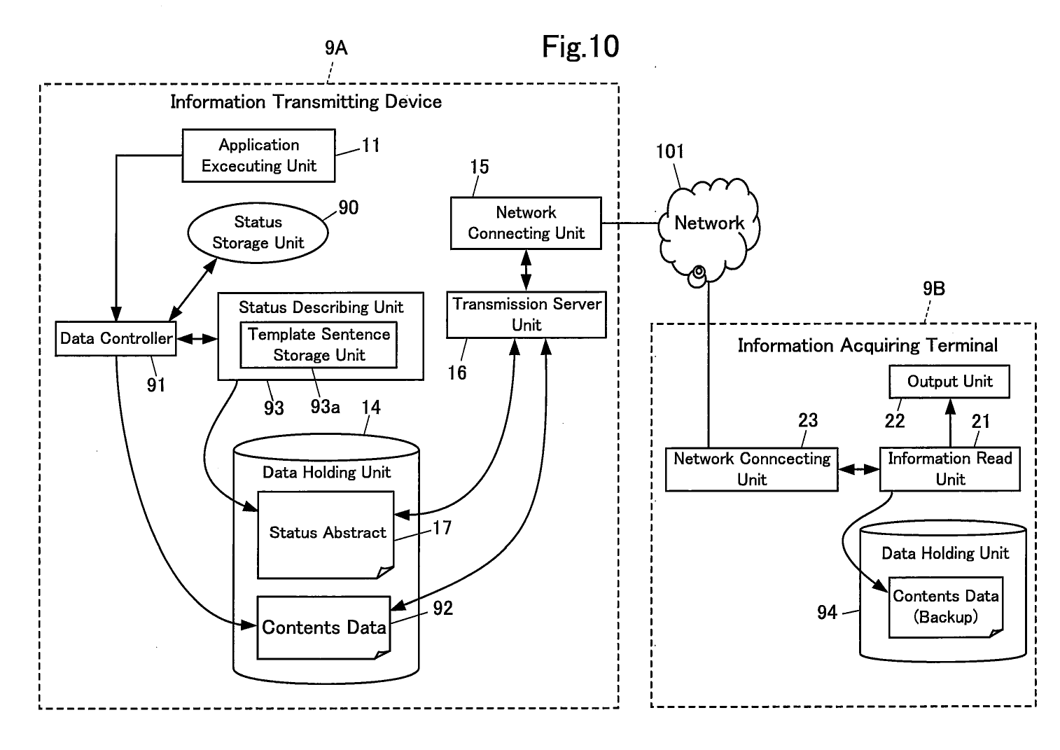

FIG. 10 is a block diagram showing an information distributing system, according to the sixth embodiment of the present invention, comprising an information transmitting device, an information acquiring terminal, and a third information terminal. The elements of the information transmitting device and information acquiring terminal according to the sixth embodiment substantially the same as those of the information transmitting device and information acquiring terminal according to the first embodiment will not be described, but bear the same reference numerals as those of the information transmitting device and information acquiring terminal according to the first embodiment.

As shown in FIG. 10, the information transmitting device 9A according to the sixth embodiment includes, in addition to elements the same as those of the information transmitting device 1 according to the first embodiment, a data controller 91 operable to store contents data produced by the application executing unit 11 in the data holding unit 14, a status storage unit 90 operable to store an operational status or a record of an operation performed by the data controller 91 in response to a request from the data controller 91, a status describing unit 93 operable to produce a status abstract 17 from the status information stored in the status storage unit 90, and a transmission server unit 16 operable to transmit, in response to a request received from another network terminal through the network connecting unit 15, the contents data or the status abstract 17 stored in the data holding unit 14. Here, the term “contents data” is intended to indicate picture data, video data, music data, digital book data, various application programs and/or the like represented as digital data.

As shown in FIG. 10, the information acquiring terminal 9B according to the sixth embodiment obtains the status abstract 17 from the information transmitting device 9A by transmitting the data transmission request to the information transmitting device 9A, and produces, from the status abstract 17, data to be outputted as image, sound and/or the like to the output unit 22. The information acquiring terminal 9B includes a data holding unit 94 in addition to elements the same as those of the information acquiring terminal 2 according to the first embodiment. The information read unit 21 of the information acquiring terminal 9B is adapted to detect contents data to be stored in the data holding unit 94 as a backup copy by using an operation identification tag detected from the status abstract 17. When the information read unit 21 detects location information about contents data to be stored in the data holding unit 94 as a backup copy of the contents data, the information acquiring terminal 9B obtains the contents data from the information transmitting device 9A by transmitting the data transmission request to the information transmitting device 9A, and stores the contents data as a backup copy of the contents data.

The following description is then directed to the operation of the information transmitting device 9A according to the sixth embodiment of the present invention. In this embodiment, the operation of the information transmitting device 9A is performed by the CPU of the information transmitting device 9A.

Firstly, the application executing unit 11 produces contents data 92 by performing a designated function, and requests the data controller 91 to store the contents data 92. In this embodiment, the information transmitting device 9A is constituted by a mobile phone. The application executing unit 11 has a digital camera function, and takes a picture by performing the digital camera function.

The data controller 91 determines free space of the data holding unit 14 in response to a request from the application executing unit 11. When the judgment is made that the data holding unit 14 has an enough free space to have the contents data stored therein, the data controller 91 stores the picture in the data holding unit 14, temporarily stores a record of a storage operation, i.e., the fact that the data controller 91 has stored the contents data 92 in a specific area of the data holding unit 14 in response to the request from the application executing unit 11, in the status storage unit 90 as the status information, and informs the status describing unit 93 of the change of the status. When, on the other hand, the status abstract has backup flag information indicating a backup instruction from another device, the data controller 91 stores the backup flag information in the status storage unit 90.

When the notice about the change of the status is received by the status describing unit 93 from the data controller 91, the status describing unit 93 reads the status information stored in the status storage unit 90, produces text data written in a natural language on the basis of the status information read from the status storage unit 90, produces a status abstract written in a markup language on the basis of the text data, and stores the status abstract in the data holding unit 14. When, for example, the backup flag information is included in the status information read from the status storage unit 90, the status describing unit 93 produces a status abstract having a uniform resource identifier (URI) of the contents data to be stored as a backup copy. For example, the URI is marked with an operation identification tag such as <Backup>, and added to the status abstract to be stored in the data holding unit 14.

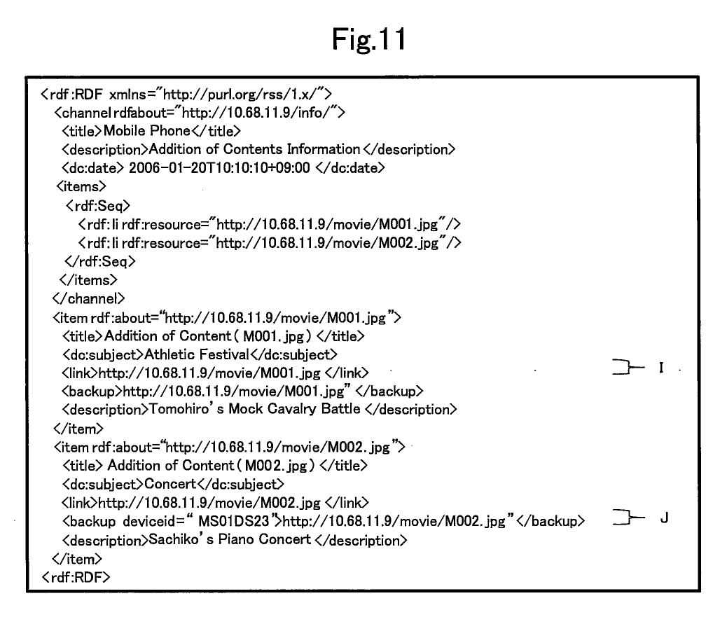

FIG. 11 is a diagram showing an example of a status abstract 17 written in a markup language and produced by the status describing unit 93. In this embodiment, the backup copy of still image data “M001.jpg” is stored in the data holding unit 14. As shown in FIG. 11, the URI of the backup copy of still image data “M001.jpg” is in a line “I” of the status abstract 17.

In this way, the status information represented by the status abstract 17 about the fact that the contents data 92 is produced by the application executing unit 11 and stored in the data holding unit 14 when the function is performed by the application executing unit 11, is obtained from the information transmitting device 9A, displayed by the output unit 22 as an image, and/or outputted by the output unit 22 as a sound through a loudspeaker.

The following description is then directed to the operation of the information acquiring terminal 9B according to the sixth embodiment of the present invention. In this embodiment, the operation of the information acquiring terminal 9B is controlled by the CPU of the information acquiring terminal 9B.

The information read unit 21 of the information acquiring terminal 9B analyzes the status abstract 17 written in a markup language and obtained from the information transmitting device 8A. The information acquiring terminal 9B transmits contends data transmission request to the transmission server unit 16 through the network connecting unit 15 of the information transmitting device 8A when detecting, from the status abstract 17, a tag “<Backup>” corresponding to a backup copy of the contents data.

The transmission server unit 16 of the information transmission device 9A transmits the contents data stored in the data holding unit 14 to the information acquiring terminal 9B in response to the contents data transmission request from the information acquiring terminal 9B.

The information read unit 21 of the information acquiring terminal 9B makes a backup copy of contents data obtained from the information transmission device 9A through the network 101 in the data holding unit 94 of the information acquiring terminal 9B.

In addition, each of the data holding unit 14 of the information transmission device 9A and the data holding unit 94 of the information acquiring terminal 9B shown in FIG. 10 has free area in which it is possible to temporarily store, update, delete, or process text file or binary file.

The contents data to be stored in each of the data holding unit 14 of the information transmission device 9A and the data holding unit 94 of the information acquiring terminal 9B shown in FIG. 10 is not restricted by formats of still image, moving picture, sound, music, text, character file, game, graphical user interface (GDI) tool, icons, playlists, dictionaries, answerphone data, images of visitors, log of moving picture, to-do list, phone book, list of events, schedule information, acquaintance list, machine information, a variety of recipes, maps, and the like.

The transmission server unit 16 of the sixth embodiment is the same in construction as that of the first embodiment, and may function as, for example, a subset of a hyper text transfer protocol server (hereinafter referred to as “HTTP server”). The transmission server unit 16 may interpret only the command “GET” from the HTTP server. The uniform resource identifier (hereinafter referred to as “URI”) defined as argument of the command “GET” may indicate only the data holding unit 14.

When the status abstract is received as a text file from the information transmitting device, the information output unit 21 analyzes the markup language of the status abstract received as a text file, extracts text data written in a natural language from the status abstract, and produces, on the basis of the extracted text data, data to be outputted to the output unit 22 to ensure that the output unit 22 displays, on a screen, image information based on the data produced by the information output unit 21, and/or outputs, through a loudspeaker, a sound based on the data produced by the information output unit 21.

The information read unit 21 may add, to data to be outputted to the output unit 22, data indicating a record of a backup operation performed to receive the contents data from the information transmitting device 9A.

The information output unit 21 may analyze only one or more specific elements of the status abstract written in a markup language. When the judgment is made that it is hard to analyze the remaining elements of the status abstract, the information output unit 21 may skip those elements of the status abstract.

When the data controller 91 of the information transmitting device 9A informs the status describing unit 93 of the change in status of the application executing unit 11, the data controller 91 may transmit information indicating not only the change in status of the application executing unit 11 but also temporarily stored record of the status of the data controller 91.

The data controller 91 of the information transmitting device 9A may function as a data folder in the information transmitting device 9A constituted by a mobile phone, a personal digital assistance (PDA), or the like. On the other hand, the data controller 91 of the information transmitting device 9A may function as a file system in the information transmitting device 9A constituted by a HDD video recorder, a personal computer, or the like.

Each of the data holding unit 14 of the information transmitting device 9A and the data controller 91 of the information acquiring terminal 9B is constituted by a built-in memory medium, a removable memory medium, or a memory medium to be connected with a device through a network, or wirelessly connected with a device.

The operation is performed by a device identified on the basis of identification information shown in a line “J” marked with <Backup> tag as shown in FIG. 11. In this embodiment, a backup copy of the contents data is made by a device identified on the basis of the device identification information “MS01DS23”.

In the information transmitting device 8A according to the sixth embodiment, the application executing unit 11 performs a function to produce contents data. When the contents data is stored in the data holding unit 14 through the data controller 91, the data controller 91 informs the status describing unit 93 of the change in status of the application executing unit 11. The status describing unit 93 obtains the status information from the status storage unit 90 in response to a notice from the data controller 91 about the change in status of the application executing unit 11, produces a status abstract written in a natural language on the basis of the status information, the status abstract indicating the status information, and stores the status abstract in the data holding unit 14. The information acquiring terminal 9B transmits data transmission request to the information transmitting device 9A, while the information transmitting device 9A transmits the status abstract to the information acquiring terminal 9B in response to the data transmission request from the information acquiring terminal 9B. The information acquiring terminal 9B obtains the status abstract 17 from the information acquiring terminal 9B, extracts the information from the status abstract 17, and produces data to be outputted to the output unit 22. When the information read unit 21 detects location information about contents data to be stored in the data holding unit 94 as a backup copy of the contents data, the information acquiring terminal 9B obtains the contents data from the information transmitting device 9A by transmitting the data transmission request to the information transmitting device 9A, and stores the contents data as a backup copy of the contents data. Therefore, unspecified number of information acquiring terminals 9B can asynchronously make a backup copy of the contents data when needed, even if even if each of the information transmitting devices 8A and the information acquiring terminals 8B has only a powerless processor and insufficient storage capacity, and the like.

While there has been described in the foregoing embodiment about the fact that the information acquiring terminal obtains the status abstract from the information transmitting device, and extracts the information written in a natural language from the status abstract, your terminal outputting a video and/or a sound on the basis of the information extracted by the information acquiring terminal, the present invention is not limited to the foregoing embodiment. For example, the information acquiring terminal may transfer the status abstract from the information transmitting device to another terminal.

### Seventh Embodiment

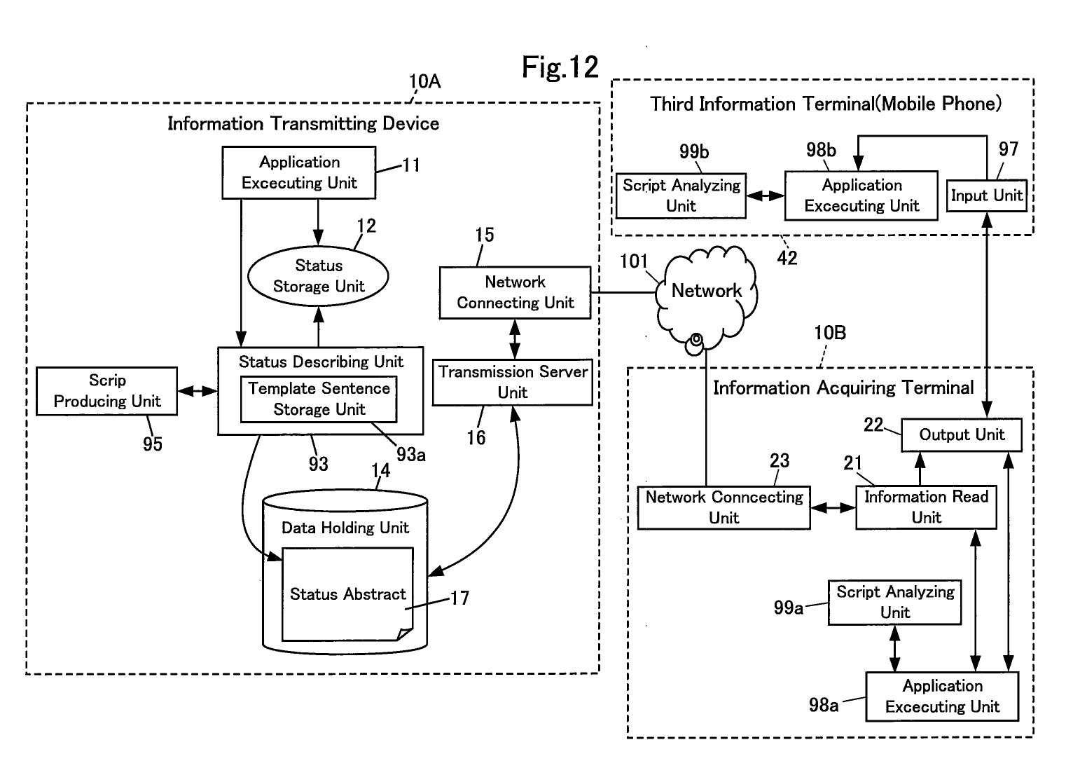

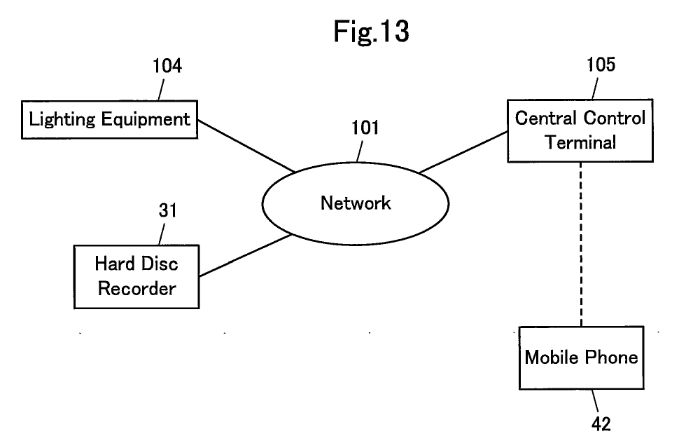

FIG. 12 is a block diagram showing an information transmitting device, an information acquiring terminal, and a third information terminal operable to execute an operation script received from the information acquiring terminal. FIG. 13 is a block diagram showing an information distributing system according to the seventh embodiment of the present invention. The information distributing system comprises an information transmitting device, an information acquiring terminal, and a third information terminal. The elements of the information transmitting device and information acquiring terminal according to the seventh embodiment substantially the same as those of the information transmitting device and information acquiring terminal according to the first embodiment will not be described, but bear the same reference numerals as those of the information transmitting device and information acquiring terminal according to the first embodiment.

As shown in FIG. 12, the information transmitting device 10A according to the seventh embodiment includes, in addition to elements the same as those of the information transmitting device 1 according to the first embodiment, a script producing unit 95 operable to produce, in response to a request from the status describing unit 93, an operation script executable in another device, and a status describing unit 93 operable to instruct, in response to a notice from the application executing unit 11, the script producing unit 93 to produce an operation script on the basis of the status information stored in the status storage unit 12, an instruction represented by the notice, or time information on a time at which the status describing unit 93 has received the notice, and operable to produce a status abstract 17 written in a markup language, and to incorporate the operation script produced by the script producing unit 95 in the status abstract 17. The status abstract 17 has a tag marking the operation script.

As shown in FIG. 12, the information acquiring terminal 10B according to the seventh embodiment includes, in addition to elements the same as those of the information acquiring terminal 2 according to the first embodiment, an information read unit 21 operable to obtain the status abstract 17 from the information transmitting device 10A by transmitting data transmission request to the information transmitting device 10A, to produce data from the status abstract 17, and to extract the operation script marked with the tag from the status abstract 17, and an application executing unit 98a operable to receive the operation script from the information read unit 21, a script analyzing unit 99a operable to analyze the operation script extracted from the status abstract 17 obtained, in response to a request from the application executing unit 98a, by the information read unit 21, and an output unit 22 operable to output, in response to a request from the information read unit 21, an image or a sound based on the data, and operable to output, in response to information from the script analyzing unit 99a, data to be processed by the application executing unit 98a.

As shown in FIG. 12, the third information terminal includes an input unit 97 operable to perform communications with another terminal to receive an operation script from the terminal, an application executing unit 98b operable to execute the operation script received by the input unit 97, and a script analyzing unit 99b operable to analyze the operation script in response to an instruction from the application executing unit 98b.

The operation of each of the information transmitting device 10A, the information acquiring terminal 10B, and the third information terminal will be then described hereinafter with reference to FIGS. 13 to 15.

As shown in FIG. 13, the information transmitting device 10A is constituted by lighting equipments 104 provided as a lighting facility in one's home. The information acquiring terminal 10B is constituted by a central control terminal 105 operable to manage the lighting equipments 104 in an integrated fashion. The third information terminal is constituted by a mobile phone 42. Each of the lighting equipments 104 has a light bulb to be changed with new light bulb as consumable supply when the light bulb has burnt out. In this embodiment, the light bulb of each of the lighting equipments 104 provided as a lighting facility in one's home is exemplified as the managed object. However, the central control terminal 105 may manage another object as the managed object if the central control terminal 105 can obtain its status information through a network. The managed object to be managed by the central control terminal 105 is not limited to an indoor object.

The application executing unit 11 of the lighting equipment 104 stores, as the status information, time and date that a light bulb is changed as consumable supply in place of the burned-out light bulb, the number of times that the light bulb is turned on after the light bulb is changed in place of the burned-out light bulb, summation time that the light bulb is on, current magnitude, time that the light bulb is frequently turned on, and the like in the status storage unit 12. The application executing unit 11 further detects the change of luminance of the light bulb by using a sensor, calculates the remaining life time of the light bulb, stores the calculated remaining life time of the light bulb as the status information in the status storage unit 12. The application executing unit 11 outputs a trigger signal to the status describing unit 93 when the calculated remaining life time of the light bulb is shorter than seven days previously determined as a threshold. The status describing unit 93 of the lighting equipment 104 produces a sentence written in a natural language such as “Please buy a light bulb under model number XXX by Jul. 10, 2005 because the light bulb is likely to be burnt out in seven days.” in response to the trigger signal from the application executing unit 11 on the basis of the status information stored in the status storage unit 12. The status describing unit 93 further requests the script producing unit 95 to produce an executable script with optional information about the model number of the light bulb, the date set for purchase and the position of the relevant lighting equipment. This executable script is executed as to-do script to urge user to buy a light bulb. In this embodiment, the status describing unit 93 produces a status abstract 17 while adding basic information useful for identifying the lighting equipment and optional information useful for supplementing the status information to the status abstract 17, and while adding the operation script to the status abstract 17 when needed. If it is not necessary to identify the lighting equipment, the status describing unit 93 may produce a status abstract 17 without the basic information. If it is not necessary to supplement the status information, the status describing unit 93 may produce a status abstract 17 without the optional information.

The information read unit 21 of the central control terminal 105 constituted as the information acquiring terminal 10B obtains the status abstract 17 from the lighting equipment 104 constituted as the information transmitting device 10A through the network 101, extracts text data written in a markup language from the status abstract 17, and produces data to be outputted as a reminder from a home appliance. In this embodiment, the information read unit 21 produces data needed to display a message “This light bulb will be probably burnt out within seven days. Please buy a XXX-type light bulb by Jul. 10, 2005.” on a screen of the output unit 22. When, for example, a user checks whether or not each home appliance is in an off state before he/she goes to work, the user can notice the message “This light bulb will be probably burnt out within seven days. Please buy a XXX-type light bulb by Jul. 10, 2005.” by noticing the message “a reminder from a home appliance” displayed on the screen of the output unit 22.

The status abstract obtained from the lighting equipment by the information read unit 21 of the central control terminal 105 includes a script written in executable format and marked with an operation identification tag. Therefore, the information read unit 21 of the lighting equipment 104 extracts the script from the status abstract, and transfers the script to the application executing unit 98a. The application executing unit 98a requests the script analyzing unit 99a to the script from the information read unit 21, judges whether or not to identify the script as to-do script on the basis of an analysis of the script, and temporarily holds the script when the script is identified as to-do script. In this embodiment, the application executing unit 98a displays a sentence or an icon to ensure that the user notice the to-do script.

The following description is directed to the case that the central control terminal 105 includes an output unit 22 as an infrared data communication function. The mobile phone 42 is specified as a third information terminal when the central control terminal 105 is operated by a user on the basis of a procedure shown by characters or/and one or more icons displayed on a screen of the central control terminal 105. The application executing unit 98b of the central control terminal 105 transfers, in response to an instruction from the central control terminal 105, the to-do script to the input unit 97 of the mobile phone 42 through the output unit 22 by performing infrared data communications with the mobile phone 42.

When the mobile phone 42 functions as the third information terminal to obtain the to-do script from the central control terminal 105, the input unit 97 of the mobile phone 42 transfers the to-do script to the application executing unit 98b, while the application executing unit 98b instructs, if necessary, the script analyzing unit 99b to analyze the to-do script. When the judgment is made that the mobile phone 42 is able to execute the to-do script, the mobile phone 42 executes the to-do script. When, for example, the application executing unit 98b of the mobile phone 42 functions as a scheduler, the application executing unit 98b of the mobile phone 42 sets Jul. 10, 2005 (as date on which you should buy a light bulb in this embodiment) on the basis of an analysis of the to-do script, and adds optional information (about the model number of the light bulb and the position of the relevant lighting equipment in this embodiment). The application executing unit 98b of the mobile phone 42 outputs today's schedule through an output unit (not shown) by performing a designated operation. For example, the application executing unit 98b of the mobile phone 42 can notify the user of the today's schedule by outputting an alarm sound. In this embodiment, the application executing unit 98b of the mobile phone 42 starts to perform the designated operation in response to the date. However, the application executing unit 98b of the mobile phone 42 starts to perform the designated operation when the user enters into an area defined on the basis of the optional information.

While there has been described in the foregoing description about the fact that the information read unit 21 of the central control terminal 105 produces, for example, data to be displayed in a screen, the information read unit 21 of the central control terminal 105 may produce data, written in a format appropriate for the output unit, such as sound data, image data, Braille data and/or the like. In this embodiment, the information acquiring terminal 10B performs the infrared data communications with the third information terminal to transfer the script to the third information terminal. However, the information acquiring terminal 10B may perform another communications with the third information terminal through, for example, wireless home network, the internet, mobile communication network, local area network (Bluetooth, secondary wireless communication network, communication performed by a noncontact IC), and the like. In this embodiment, the information acquiring terminal transfers the script to the third information terminal in response to user's instruction. However, the information acquiring terminal may automatically transfer the script to the third information terminal.

The following description is directed to the case that the information transmitting device 10A is constituted by a hard disc video recorder 31 in one's living room or the like.

The hard disc video recorder 31 constituted as the information transmitting device 10A includes a status storage unit 12 operable to obtain, from the Electronic Program Guide (simply referred to as “EPG”) and basis information about television program distributed on the Internet, added timer recording information, television program information such as for example title, category, airdate, channel, subtitle, cast, synopsis and the like of the television program recorded in the hard disc video recorder 31.

The status describing unit 93 requests the script producing unit 95 to produce a script on the basis of the status information stored in the status storage unit 12, and produces a status abstract written in a markup language by marking the script produced by the script producing unit 95 with an operation identification tag. Here, the status describing unit 95 may produce a television program transferring script and a timer recording which may contain title, category, airdate, channel, subtitle, and the like.

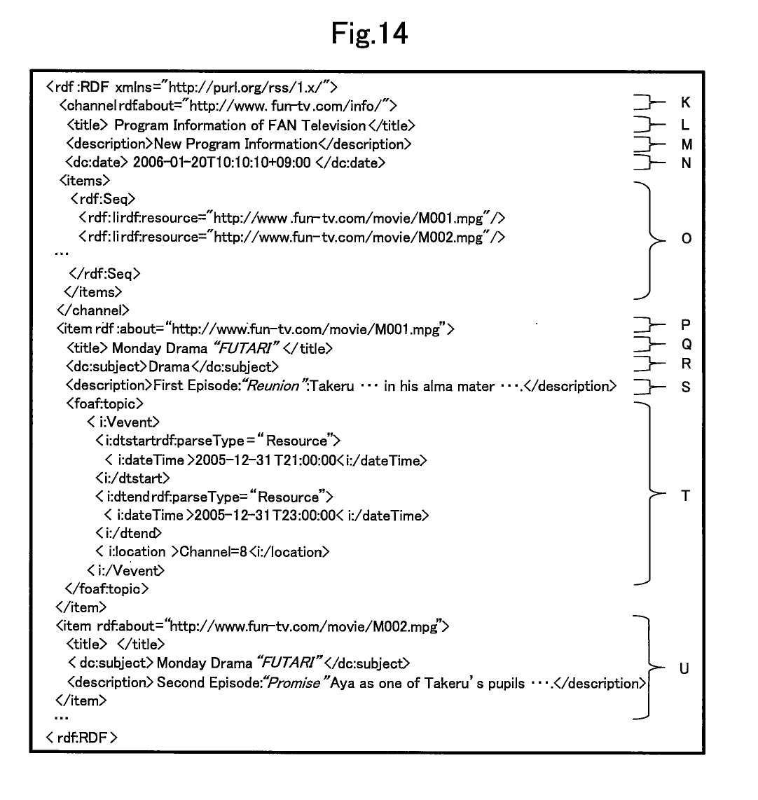

FIG. 14 is a diagram showing an example of a status abstract written in a markup language and produced, in response a notice from the application executing unit 11, by the status describing unit 93 of the hard disc video recorder 31 constituted as the information transmitting device. In this embodiment, the RSS format or the Atom format is used in a markup language.

The status describing unit 93 extracts basic information such as for example machine name, model name, owner, position and the like from the status abstract 17 in response to a notice from the application executing unit 11, and produces text data written in a natural language and marked with <title> tag and <description> tag (lines “L” and “M” in FIG. 14). The status describing unit 93 reads TV program information from the status storage unit 12, marks a list of the TV program information with <rdf:li> tag under <item> tag (lines “O” in FIG. 14). The status describing unit 93 receives, converts in format if necessary, and marks time information “on Jan. 20, 2006 at 10:10 Japan time” with <dc:date> tag (line “N” in FIG. 14). The status describing unit 93 marks the above information as basic information of contents with <channel> tag (line “K” in FIG. 14).

The status describing unit 93 reads information from the TV program information stored in the status storage unit 12, and marks the information with <item> tag (lines “P” and “U” in FIG. 14) after the basis information (marked with <channel> tag). For example, the title “Monday Drama “FUTARI”” is marked with <title> tag (line “Q” in FIG. 14). The category of this TV program is marked with <dc:subject> tag (line “R” in FIG. 14). The subtitle of this TV program is marked with <description> tag (line “S” in FIG. 14). Here, the broadcast time of this TV program is marked with <description> tag (line “T” in FIG. 14). The start time of this TV program is marked with <i:dtstart> tag under <i:Vevent> tag. The end of this TV program is marked with <i:dtend> tag. The channel of this TV program is marked with <i:location> tag. When the information read unit 21 of the information acquiring terminal 10B detects an operation identification tag such as <foaf:topic> tag from the status abstract 17, the information read unit 21 of the information acquiring terminal 10B extracts the timer recording script as an executable script. When, for example, the central control unit 105 obtains the status abstract 17 including timer recording information, the output unit 22 of the central control unit 105 can transfer the timer recording script to the mobile phone 42 constituted as third information terminal.

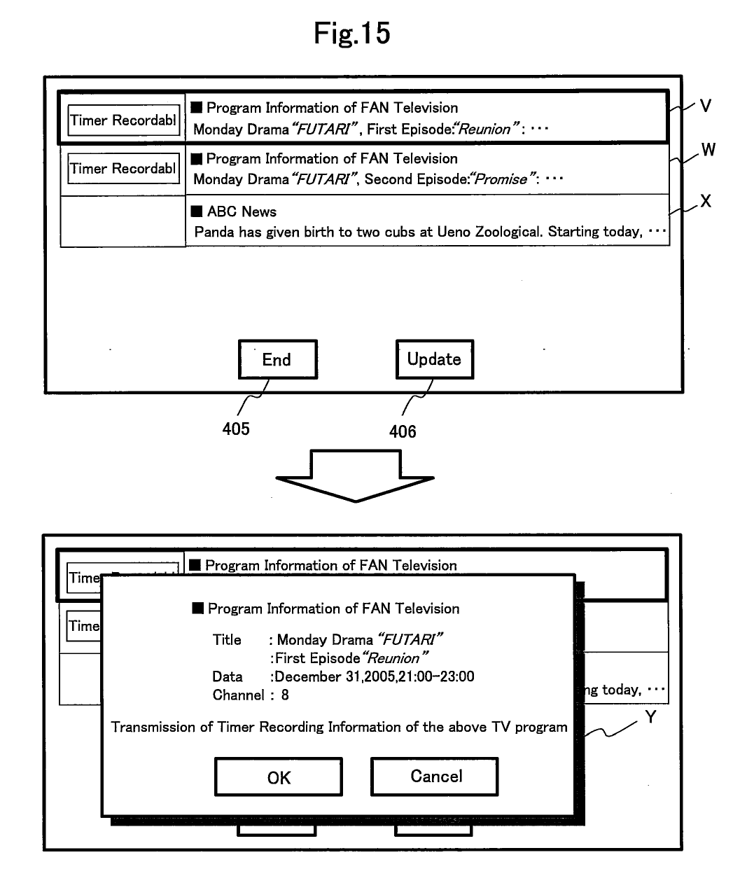

FIG. 15 is a diagram showing an example of information to be obtained by a central control terminal 105 constituted as the information acquiring terminal 10B from the hard disc video recorder 31 constituted as the information transmitting device 10A, and to be displayed by the central control terminal 105. For example, the hard disc video recorder 31 produces the status abstract 17 shown in FIG. 14. When the central control terminal 105 obtains the status abstract 17 from the hard disc video recorder 31 by performing infrared data communication with the hard disc video recorder 31, the information read unit 21 of the central control terminal 105 analyzes the status abstract 17, and outputs an image on a screen of the output unit 22 (see upper side of FIG. 15). The text data extracted from the status abstract 17 and written in a natural language, and the executable script are displayed on sections V and W of FIG. 15.

When the TV program information displayed in a section “V” of FIG. 15 is selected by a user, a pop-up image indicating the selected TV program information appears on a screen as shown in the lower half of FIG. 15. The information read unit 21 extracts the TV program information and the timer recording script from the obtained status abstract 17, asks a user whether or not to transmit the timer recording script. When the user pushes a button “OK” (shown in FIG. 15), the central control terminal 105 transmits the TV program information and the timer recording script to the mobile phone 42 constructed as the third information terminal by performing infrared data communications with the mobile phone 42. The input unit 97 of the mobile phone 42 constituted as the third information terminal shown in FIG. 12 receives the TV program information and the timer recording script. The application executing unit 98b executes and completes the timer recording script on the basis of the timer recording information received from the central control terminal 105.

While there has been described as an example in the seventh embodiment about the fact that the information acquiring terminal 10B outputs the TV program information and the timer recording script to the third information terminal by performing infrared data communications with the third information terminal, the information acquiring terminal 10B may be constituted as a device operable to set a timer to have the hard disc video recorder 31 perform a timer recording operation, may include an input unit 97 and an application executing unit 98b, and may execute the timer recording script extracted from the status abstract 17.

In this embodiment, the information acquiring terminal 10B asks a user about the type of the script extracted from the status abstract. However, the information acquiring terminal 10B may automatically execute the script, if necessary, without asking a user about the type of the script.

In this embodiment, the status information includes information to be outputted by a hard disc video recorder and another information device. The information includes still image data, video data, text data and/or digital data to be outputted by a data processing equipment such as for example hard disc video recorder. The information transmitting device may be constituted by for example non-contact type automatic ticket checker, music download terminal, ticket vending machine, and the like operable to distribute ticket information and event information. When, for example, the judgment is made by a door sensor on whether or not the front door is in a locked state, and the judgment is made by a human detection sensor whether or not there is nobody at home right now, the door sensor constituted as an information transmitting device produces a turn off script useful to turn off light bulbs of each room, and produces a check script useful to check whether or not you turned off the gas at the main. The lighting equipment constituted as an information acquiring terminal receives the status abstract 17 from the door sensor, extracts the turn off script from the status abstract 17, and executes the turn off script. The gas sensor constituted as an information acquiring terminal receives the status abstract 17 from the door sensor, extracts the turn off script from the status abstract 17, and executes the turn off script.

The network 101 is constituted by one or more networks such as for example wireless home network, the Internet, mobile communication network, and local wireless network. The secondary wireless communications such as for example Bluetooth and infrared data communications, communications with non-contact IC card, or another communication can be performed through the network 101.

In the information transmitting device 10A according to the seventh embodiment, the application executing unit 11 performs various sensing functions to output measurement data as status information. The status storage unit 12 stores the measurement data from the application executing unit 11. The status describing unit 93 requests the script producing unit 95 to produce a script to be executed by another device on the basis of the status information stored in the status storage unit 93, and produces a status abstract 17 with the script from the script producing unit 95 and the status information stored in the status storage unit 12, and stores the status abstract 17 on the data holding unit 14. In the information acquiring terminal 10B according to the present invention, the information read unit 21 transmits the data transmission request to the transmission server unit 16 of the information transmitting device 10A through the network 101 and the network connecting unit 15 of the information transmitting device 10A, obtains the status abstract 17 from the information transmitting device 10A, extracts information from the status abstract 17, and produces, on the basis of the extracted information, data to be displayed on the screen of the output unit 22, judges whether or not the status abstract 17 includes a script on the basis of the operation identification tag detected from the status abstract 17. When the status abstract 17 includes a script, the information read unit 21 transfers the script to the application executing unit 98a. The application executing unit 98a requests the script analyzing unit 99a to analyze the script from the information read unit 21. The script analyzing unit 99a analyzes whether or not the script is executable in the relevant information acquiring terminal 10B. The application executing unit 98a, for example, displays the information extracted from the status abstract 17 on the screen of the output unit 22, executes the script, or requests the output unit 22 to transfers the script to the input unit 97 of the third information terminal. More specifically, even if each of the information transmitting device 10A and the information acquiring terminal 10B has only a powerless processor and insufficient storage capacity, the information acquiring terminal 10B can transmit the script to the third information terminal through the output unit 22. As an example, the judgment is made by the lighting equipment 104 on whether or not the remaining life of the light bulb of the lighting equipment 104 exceeds a predetermined value. When the remaining life of the light bulb of the lighting equipment 104 does not exceeds a predetermined value, the lighting equipment 104 produces to-do script useful to urge a user to buy a light bulb. The central control unit 105 can prevent the user from forgetting to buy a light bulb by transmitting the to-do script to the mobile phone 42. As another example, the judgment is made by the central control terminal 105 on whether or not the remaining free space of the hard disc of the hard disc video recorder 31 exceeds a space needed to have a designated TV program recorded therein. When the remaining free space of the hard disc of the hard disc video recorder 31 is too short to have a designated TV program recorded therein, the central control terminal transfers the to-do script to another video recorder to ensure that the TV program is recorded in another video recorder.

### INDUSTRIAL APPLICABILITY OF THE PRESENT INVENTION

As will be seen from the foregoing description, the information transmitting device according to the present invention has an effect of transmitting information through a network even if the information transmitting device has a powerless processor and insufficient storage capacity, the information acquiring terminal according to the present invention has an effect of receiving information through the network even if the information acquiring terminal has a powerless processor and insufficient storage capacity, the information distributing system provided with the information transmitting device and information acquiring terminal is useful as an information distributing system which can collect and transmit inside information and status information of each home appliance, and measurement data of each sensor node.

1-21. (canceled)

22. An information transmitting device, comprising:
a status storage unit operable to store status information indicating a status of an appliance, said status of said appliance fluctuating with time;
a network connecting unit operable to perform communications with an external terminal through a network;
a status describing unit operable to produce a sentence written in human readable natural language on the basis of said status information, and to produce a status abstract written in a markup language by marking said sentence, said status abstract including external terminal readable operation script marked;
a data holding unit operable to store said status abstract, and
a transmission server unit operable to transmit said status abstract stored in said data holding unit in response to a data transmission request received through said network.

23. An information transmitting device according to claim 1, wherein
said status describing unit adds identification information to said operation script to be executed by a terminal to ensure that said terminal is designated on the basis of said identification information.

24. An information transmitting device according to claim 1, wherein
said status storage unit has schedule information indicating a plan of an operation to be performed by an appliance.

25. An information acquiring terminal, comprising:
a network connecting unit operable to perform communications with an external device through a network;
an information extracting unit operable to receive a status abstract from an information transmitting device of claim 1 through said network, and to extract a sentence written in human readable natural language and an operation script from said status abstract;
an information output unit operable to output said sentence; and
an operation script executing unit operable to execute said operation script.

26. An information acquiring terminal according to claim 4, which further comprises an identification information extracting and judging unit operable to extract, from said operation script, identification information to be used to designate a terminal, and to judge whether or not to identify a relevant terminal as a designated terminal on the basis of said identification information, wherein
when said relevant terminal is identified as said designated terminal by said identification information extracting and judging unit, said operation information extracting and executing unit executes said operation script.

27. An information acquiring terminal according to claim 4, wherein
said information output unit transfers said operation script extracted by said information extracting unit to a third terminal by using short distance communication means.

28. An information distributing system, comprising:
an information transmitting device including: a status storage unit operable to store status information indicating a status of an appliance, said status of said appliance fluctuating with time; a network connecting unit operable to perform communications with an external terminal through a network; a status describing unit operable to produce a sentence written in human readable natural language on the basis of said status information, and to produce a status abstract written in a markup language by marking said sentence, said status abstract including external terminal readable operation script; a data holding unit operable to store said status abstract, and a transmission server unit operable to transmit said status abstract stored in said data holding unit in response to a data transmission request received through said network, and
an information acquiring terminal including: a network connecting unit operable to perform communications with an external device through a network; an information extracting unit operable to receive a status abstract from an information transmitting device of claim 1 through said network, and to extract a sentence written in human readable natural language and an operation script from said status abstract; an information output unit operable to output said sentence; and an operation script executing unit operable to analyze said operation script extracted by said information extracting unit, to judge whether or not to allow a relevant terminal to execute said operation script, and to execute said operation script.

29. An information distributing system according to claim 7, which further comprises an identification information extracting and judging unit operable to extract, from and operation script, identification information to be used to designate a terminal, and to judge whether or not to identify said relevant terminal as a designated terminal on the basis of said identification information, wherein
when said relevant terminal is identified as said designated terminal by said identification information extracting and judging unit, said operation information extracting and executing unit executes said operation script.

30. An information distributing system according to claim 7, wherein
said status storage unit has schedule information indicating a plan of an operation to be performed by an appliance.
